(19) United States
(12) Patent Application Publication
(10) Pub. No.: US 2025/0145390 A1
(43) Pub. Date: May 8, 2025

(54) GRIPPER HEAD AND METHOD FOR HANDLING PACKAGING BLANKS

(71) Applicant: Krones Aktiengesellschaft, Neutraubling (DE)

(72) Inventors: August PEUTL, Woerth an der Donau (DE); Martin WAGNER, Regensburg (DE); Rudolf GRUENDL, Halfing (DE); Andreas HACK, Osterhofen (DE)

(21) Appl. No.: 18/939,796

(22) Filed: Nov. 7, 2024

(30) Foreign Application Priority Data
Nov. 8, 2023 (DE) 10 2023 130 970.6

(51) Int. Cl. B65G 47/91; B65B 43/18

(52) U.S. Cl. CPC B65G 47/91; B65B 43/185; B65G 2201/0235

(57) ABSTRACT

A gripper head (10) for manipulating packaging blanks is disclosed.

The gripper head (10) comprises an upper gripping unit (17) and a lower gripping unit (19) which are configured for the joint tight gripping of a plurality of packaging blanks from a stack (50) having a large number of packaging blanks. Furthermore, the gripper head (10) comprises a separating unit which is configured to lift outer edges of given packaging blanks intended for being tightly gripped.
The separating unit comprises a linear actuator (16) for lifting the outer edges, which actuator is arranged in such a way that its rectilinear lifting axis is inclined relative to a contact surface of the lower gripping unit (19) when the separating unit (18) lifts the outer edges of the given packaging blanks via the linear actuator (16).

### CLAIM OF PRIORITY

The present application claims priority to German Application DE 10 2023 130 970.6 filed Nov. 8, 2023, which is incorporated by reference.

### FIELD OF THE INVENTION

The present invention relates to a gripper head and a method for manipulating packaging blanks. The invention also relates to a packaging system.

### BACKGROUND OF THE INVENTION

In order to be able to package articles using packaging blanks, it is necessary for the given packaging blanks to be first manipulated and, in so doing, removed from a stack and taken to a predefined destination.

Such a destination may be, for example, a packaging machine that packages articles with the given packaging blanks. A packaging machine can already accommodate a larger quantity of packaging blanks which it accesses to package items. To ensure that the stock is not exhausted after a certain period, new packaging blanks are regularly transferred into the packaging machine. In practice, manipulators are used for this purpose which can successively remove a plurality of packaging blanks with a gripper head from a stack and then transfer them to the given packaging machine.

Removing packaging blanks using a gripper head can be associated with problems since the individual packaging blanks in stacked form on top of one another cannot be adequately tightly gripped in order to subsequently transport them to the packaging machine. In a given receipt with clamping, it cannot be completely ruled out that individual packaging blanks of the stack will be bent or damaged by the gripper head during receipt. It cannot also be completely ruled out that flat packaging blanks may unintentionally be released by the gripper head after they have been inadequately tightly gripped by the given gripper head.

Furthermore, manipulators known from the state of the art which receive packaging blanks from a stack and transfer them to a packaging machine often possess little flexibility while manipulating packaging blanks having different formats. As a rule, a gripper head of the given manipulator must be replaced if packaging blanks having different formats are to be received successively over time from a pallet and transferred to a packaging machine.

An object of the invention can therefore be considered that of providing a way by which flat packaging blanks can be picked up from a stack and manipulated securely and with little or no risk of damage. Furthermore, a way should be provided with which packaging blanks having different formats can be received and manipulated easily and simply.

The above objects are achieved by the subject matter that comprises the features in the independent claims. Further advantageous embodiments are described by the dependent claims.

### SUMMARY OF THE INVENTION

The invention relates to a gripper head for manipulating packaging blanks. The packaging blanks may, for example, be packaging blanks that are made at least partially or even entirely from cellulose-containing material. In further embodiments, the packaging blanks may be made at least partially or even entirely from plastics material. It is also conceivable that the packaging blanks are made at least partially or even entirely of aluminum. In addition or as an alternative to the mentioned materials, the packaging blanks may possess tabs that can be folded in an upward direction. A given packaging blank may also be a so-called PAD which provides a flat support surface for a plurality of items.

The gripper head comprises an upper gripping unit and a lower gripping unit which are configured for jointly tightly gripping a plurality of packaging blanks from a stack having a large number of packaging blanks. The upper gripping unit and the lower gripping unit may be configured in such a way that the upper gripping unit and the lower gripping unit can carry out a feed movement in which the upper gripping unit and the lower gripping unit reduce their relative distance from one another and thereby jointly tightly grip a plurality of packaging blanks.

The gripper head may comprise a rack on which the upper gripping unit and the lower gripping unit are arranged. The rack may be a plurality of sheet metal parts welded together.

Furthermore, the gripper head comprises a separating unit which is configured to lift outer edges of given packaging blanks intended for being tightly gripped relative to packaging blanks remaining on the stack so that the lower gripping unit can be inserted into the stack of packaging blanks in the region of the raised outer edges.

It is provided that the separating unit for lifting the outer edges comprises a linear actuator which is arranged in such a way that its rectilinear lifting axis is inclined relative to a contact surface formed by the lower gripping unit when the separating unit lifts the outer edges of the given packaging blanks via the at least one linear actuator. By inclining the lifting axis relative to the contact surface, it can be avoided with a high degree of likelihood that packaging blanks will not become unintentionally detached from the separating unit when lifting their outer edges.

This allows packaging blanks to be subsequently picked up from the stack and manipulated securely and with no or lesser risk of damage. In addition, using the separating unit and the described lifting axis, packaging blanks having different formats can be received and manipulated easily and simply.

It is not absolutely necessary that at least one linear actuator is controlled to lift the outer edges of the given packaging blanks. In various embodiments, the gripper head may be guided under force against the given packaging blanks to be clamped in reception, whereby the given packaging blanks to be clamped in reception move a piston of the at least one linear actuator along the rectilinear lifting axis, and the outer edges of the given packaging blanks to be clamped in reception are lifted above the separating unit.

The gripper head may be configured in such a way that a force with which the piston of the at least one linear actuator counteracts the given packaging blanks to be clamped in reception can be adjusted. If the at least one linear actuator is at least one pneumatic cylinder, it may be that a working pressure of the at least one pneumatic cylinder can be adjusted via a control and/or regulating device of the gripper head.

In various embodiments, the at least one linear actuator may thus be at least one pneumatic cylinder. However, the invention is not limited thereto so that in further embodiments, the at least one linear actuator may also be, for example, at least one electric linear motor or at least one electromagnetic direct drive.

The rectilinear lifting axis may be inclined relative to the contact surface at an angle that is between 5° and 30°, in particular between 10° and 25° and preferably between 15° and 20°. In particular, the rectilinear lifting axis may be inclined relative to the contact surface at an angle which is substantially 18°. Such embodiments allow the further reduction of the risk of packaging blanks unintentionally detaching from the separating unit while lifting their outer edges. The picking up and tightly gripping of packaging blanks is further improved by the described angles.

The upper gripping unit may comprise at least two fork prongs oriented parallel to one another. It is also possible for the upper gripping unit to be configured as a molded part which cooperates with the lower gripping unit to jointly tightly grip a plurality of packaging blanks from a stack. The molded part may, for example, be a sheet metal part or a further part that provides a flat clamping surface for the given plurality of packaging blanks to be tightly gripped.

Alternatively or in addition thereto, the lower gripping unit may comprise at least two fork prongs oriented parallel to one another. Here, too, it is conceivable that the lower gripping unit is configured as a molded part which cooperates with the upper gripping unit for the joint tight gripping of a plurality of packaging blanks from a stack and provides the aforementioned contact surface for packaging blanks. If the lower gripping unit comprises at least two fork prongs oriented parallel to one another, the at least two fork prongs oriented parallel to one another can have the aforementioned contact surface or form the aforementioned contact surface.

Furthermore, the lower gripping unit may comprise two outer fork prongs and two inner fork prongs, wherein the two outer fork prongs and/or the two inner fork prongs are adjustable in such a way that the two outer fork prongs can be brought into a common plane with the two inner fork prongs. Alternatively or in addition thereto, the two outer forks may be adjustable along their given longitudinal axes and relative to the aforementioned rack of the gripper head.

Embodiments have proven useful in which the lower gripping unit comprises at least four fork prongs oriented parallel to one another, wherein two inner fork prongs of the at least four fork prongs oriented parallel to one another are adjustable in such a way that the two inner fork prongs can be brought into a first position in which the two inner fork prongs are in a common plane with the two outer fork prongs and can be brought into a second position in which the two inner fork prongs have left this plane.

The gripper head may comprise at least one actuator via which the two inner forks can be transferred from the first position to the second position. Because the two inner fork prongs and the two outer fork prongs are in a common plane in the first position, packaging blanks picked up by the gripper head can in this case be carried both by the two inner fork prongs as well as by the two outer fork prongs. In practice, it may be necessary to use the same gripper head to also pick up packaging blanks that possess small dimensions.

The two outer fork prongs may not be necessary in this case to carry such packaging blanks. The two inner fork prongs may therefore be in the second position when the two outer fork prongs are not needed to carry the plurality of packaging blanks. The described embodiment therefore possesses a high degree of flexibility in the picking up and manipulation of packaging blanks having different dimensions.

In particular, the gripper head may comprise at least one fork prong which is configured in such a way that it can be moved into a pallet to pick up a pallet. This makes it easy also to manipulate pallets in addition to packaging blanks. Alternatively or additionally, the gripper head may comprise at least one clamping and/or gripping element by which the gripper head can hold a pallet. The at least one clamping and/or gripping element may be, for example, at least one gripping finger and/or at least one gripping hook. The at least one clamping and/or gripping element may also be at least two clamping and/or gripping jaws which can jointly receive a given pallet in a friction-locking and/or positive-locking manner.

Even with such embodiments, pallets in addition to packaging blanks can be manipulated in a simple manner.

In addition or as an alternative thereto, the lower gripping unit may comprise at least four fork prongs oriented parallel to one another, wherein two outer fork prongs of the at least four fork prongs oriented parallel to one another are adjustable via a linear guide of the gripper head in such a way that the two outer fork prongs of the at least four fork prongs oriented parallel to one another can move along their longitudinal direction.

Furthermore, the upper gripping unit and/or the lower gripping unit may be arranged on a straight guide, wherein the upper gripping unit and/or the lower gripping unit is/are moved along the straight guide for tightly gripping the given plurality of packaging blanks. It is possible that the upper gripping unit is assigned a pneumatic cylinder via which the upper gripping unit can be moved along the straight guide. It is also possible that the upper gripping unit is assigned an electric linear drive via which the upper gripping unit can be moved along the straight guide.

It is also possible that the upper gripping unit is configured to be pivotable in order to tightly grip the given plurality of packaging blanks. The upper gripping unit may comprise a sheet metal part which is pivotable in such a way that it can be placed on a given upper packaging blank of the given plurality of packaging blanks by a pivoting movement for tightly gripping the given plurality of packaging blanks.

Embodiments in which the upper gripping unit is configured to be pivotable have proven themselves in practice for transferring the upper gripping unit into a defined waiting position. If the upper gripping unit is in such a defined waiting position, the gripper head can be moved very close to a destination to which the gripper head subsequently transfers the picked-up packaging blanks. The manipulation and in particular the transfer of packaging blanks to a predefined destination may thus be further improved if the upper gripping unit is configured to be pivotable.

In various embodiments, the separating unit may be arranged on the lower gripping unit.

Embodiments in which the separating unit is arranged on the upper gripping unit have also proven themselves.

It may be that the separating unit has a carriage on which the at least one linear actuator is arranged, wherein the carriage can be moved in a straight line along a guide of the gripper head together with the at least one linear actuator. If the separating unit is arranged on the lower gripping unit, it may be the case here that the guide is provided via the lower gripping unit of the gripper head. If the separating unit is arranged on the upper gripping unit, it may be the case that the guide is be provided via the upper gripping unit of the gripper head.

In such embodiments, it may be that the gripper head has at least one actuator and a toothed belt or a spindle, wherein the carriage can be moved in a straight line by the at least one actuator via the toothed belt or via the spindle along the guide together with the at least one linear actuator.

It is also possible that the separating unit has a stop that can be moved via the linear actuator and is configured for flush alignment of the outer edges of the packaging blanks intended for the given tight gripping. The stop may form a contact surface for the given packaging blanks intended for being tightly gripped, which contact surface is elastically flexible. This can reduce the risk of packaging blanks being accidentally damaged if their surface comes into contact with the stop.

The stop may be movable via the linear actuator in such a way that the stop executes an inclination movement oriented in the direction opposite the outer edges during the lifting of the outer edges. In this case, the stop can at least partially lose any previously formed surface contact with the outer edges. It is also possible for the stop to be connected to the at least one linear actuator in such a way that the stop is inclined in the direction opposite the outer edges when the stop flushly aligns the outer edges of the packaging blanks intended for the given tight gripping. Practice has shown that such embodiments may further reduce the risk that packaging blanks lifted above the separating unit will unintentionally detach from the separating unit.

Furthermore, the separating unit may comprise a projection for lifting the outer edges of the given packaging blanks intended for being tightly gripped. If the separating unit possesses the aforementioned stop, the projection may extend beyond the stop. The projection may taper toward its free end and, in particular, may come to a point toward its free end.

In such embodiments, it may be avoided that packaging blanks are damaged when the projection plunges into the stack of packaging blanks. The projection may be movable along the rectilinear lifting axis by the linear actuator. During this movement, the outer edges of the packaging blanks intended for being tightly gripped can be lifted over the projection of the separating unit.

The gripper head may also possess at least one suction instrument which is configured in such a way that the gripper head can pneumatically receive a packaging blank via the at least one suction instrument as an alternative to tightly gripping a plurality of packaging blanks. Embodiments have proven effective in which a position of the at least one suction instrument can be adjusted by an actuator or in which the gripper head comprises at least one actuator via which the at least one suction instrument can be brought into a plurality of different relative positions with respect to a rack of the gripper head.

If a last packaging blank remains from a given stack of packaging blanks, in such embodiments the last packaging blank may also be picked up with the aid of the suction instrument and brought to a given destination. Such embodiments have therefore proven themselves in allowing all packaging blanks of a given stack to be gripped in a simple manner via the gripper head. It may be the case that the gripper head comprises exactly one suction instrument. In further embodiments, the gripper head may, for example, also comprise exactly two suction instruments or exactly three suction instruments.

The invention also relates to a manipulator to which at least one gripper head for manipulating packaging blanks is connected according to at least one exemplary embodiment of the preceding description.

The manipulator may be an articulated arm robot. The manipulator may therefore possess at least one movable working arm on which at least one movable working arm the at least one gripper head is arranged. As an alternative thereto, the manipulator may be a gantry system or a delta kinematic robot.

The invention also relates to a packaging system. The packaging system comprises a supply device for receiving at least one stack of flat packaging blanks, at least one manipulator according to at least one exemplary embodiment of the preceding description, and a packaging device for packaging articles using packaging blanks. In the packaging system, it is provided that the supply device and the packaging device are located within a working range of the at least one manipulator, wherein the at least one manipulator is configured to transfer packaging blanks in each instance tightly gripped by its gripper head to the packaging device.

The packaging device may be configured for packaging articles using packaging blanks, wherein the articles are beverage containers.

In particular, the gripper head may comprise at least one fork prong which is configured in such a way that it can be moved into a free space formed by the pallet in order to pick up a pallet. This makes it easy to manipulate also pallets in addition to packaging blanks using the gripper head. If a pallet is described in connection with the present patent application, it may be a commercially available Euro pallet.

The invention further relates to a method for manipulating packaging blanks via a gripper head which possesses a lower gripping unit and an upper gripping unit as well as a separating unit. Features which have already been described above with regard to various embodiments of the gripper head, or to various embodiments of the manipulator, or to various embodiments of the packaging system according to the invention may also be provided in the embodiments of the method according to the invention described below and are not mentioned repeatedly.

It may be that the method is implemented or carried out with at least one gripper head, or with at least one manipulator, or with at least one packaging system according to at least one of the embodiments already described above. Likewise, features described below with regard to the embodiments of the method according to the invention may be provided in the previously described embodiments of the gripper head or of the manipulator or packaging system without being mentioned again.

The packaging system or the manipulator or the gripper head may be configured or used to carry out or implement the embodiments of the method according to the invention described below.

In the method, a stack of packaging blanks is provided. Furthermore, a gripper head lifts outer edges of given packaging blanks to be clamped in reception relative to other packaging blanks remaining on the stack by a lifting movement caused by a linear actuator of the separating unit, which lifting takes place along a rectilinear lifting axis, which rectilinear lifting axis is inclined with respect to a contact surface for packaging blanks formed by the lower gripping unit, whereupon the lower gripping unit is subsequently introduced into the stack of packaging blanks in the region of the raised outer edges.

Furthermore, the lower gripping unit inserted into the stack, together with the upper gripping unit, subsequently tightly grips the given packaging blanks. The upper gripping unit and the lower gripping unit can carry out a feed movement in which they reduce their relative distance from one another, as a result of which the given packaging blanks are tightly gripped via the upper gripping unit and the lower gripping unit.

Even in the method according to the invention, it is not absolutely necessary for the at least one linear actuator to be controlled in order to lift the outer edges of the given packaging blanks. In various embodiments, the gripper head may be guided under force against the given packaging blanks to be clamped in reception, whereby the given packaging blanks to be clamped in reception move a piston of the at least one linear actuator along the rectilinear lifting axis, and the outer edges of the given packaging blanks to be clamped in reception are lifted above the separating unit.

It may be that a force with which the piston of the at least one linear actuator counteracts the given packaging blanks to be clamped in reception is set before the separating unit lifts the outer edges of the given packaging blanks. If the at least one linear actuator is at least one pneumatic cylinder, it is possible that a working pressure of the at least one pneumatic cylinder is set via a control and/or regulating device of the gripper head before the separating unit lifts the outer edges of the given packaging blanks.

In addition, the gripper head is moved together with the tightly gripped packaging blanks toward a predefined destination. A manipulator may be provided which is in particular an articulated arm robot, wherein the manipulator moves the gripper head together with the tightly gripped packaging blanks in the direction of the predefined destination.

The destination may in particular be a packaging device which is configured for packaging articles using packaging blanks. The tightly gripped packaging blanks can be transferred from the gripper head to the packaging device. The packaging device can package articles with the transferred packaging blanks, wherein the articles are beverage containers.

In the method, the gripper head may comprise at least one fork prong with which the gripper head picks up a pallet from which all packaging blanks have previously been removed by the gripper head. A manipulator can transfer the pallet to a destination by the manipulator moving the gripper head and the pallet picked up by the gripper head to the destination.

In preferred embodiments, the rectilinear lifting axis of the linear actuator of the separating unit during the lifting movement may be inclined relative to the contact surface at an angle which is between 5° and 30°, in particular between 10° and 25° and preferably between 15° and 20°.

Embodiments have also proven themselves in which the rectilinear lifting axis of the linear actuator of the separating unit is inclined relative to the contact surface during the lifting movement at an angle which is substantially 18°.

A stop can be connected to the linear actuator, wherein the gripper head is moved in the direction of the given packaging blanks to be tightly gripped before lifting the outer edges so that the stop comes into surface contact with the outer edges still to be lifted and aligns the outer edges of the packaging blanks still to be lifted flush or substantially flush with one another.

It is also conceivable that the stop is inclined in the direction opposite the given packaging blanks by a return stroke movement of the linear actuator, while the outer edges of the given packaging blanks are raised above the separating unit. It is also possible that the stop possesses an orientation that is inclined in the direction opposite the outer edges, while the stop aligns the outer edges of the packaging blanks still to be lifted flush or substantially flush with one another.

Alternatively or in addition thereto, the stop may be connected to the linear actuator in such a way that the stop is inclined in the direction opposite the outer edges during flush alignment of the given outer edges.

In various embodiments, a stop wall may be provided counter to or in the direction of which stop wall the stop of the gripper head presses the given packaging blanks to be tightly gripped and, in doing so, aligns the outer edges of the packaging blanks still to be lifted flush or substantially flush with one another.

A projection can be connected to the linear actuator, which projection is inserted into the stack of packaging blanks to lift the outer edges so that the given packaging blanks to be tightly gripped stand upright on the projection, whereupon the projection is subsequently moved along the lifting axis by a return stroke movement of the linear actuator and, in doing so, lifts the outer edges of the given packaging blanks to be clamped in reception relative to the further packaging blanks remaining on the stack.

Furthermore, the lower gripping unit may comprise at least two inner fork prongs and at least two outer fork prongs, wherein only the at least two inner fork prongs are inserted into the stack in the region of the raised outer edges and pick up the given packaging blanks to be tightly gripped so that the given packaging blanks to be tightly gripped are completely carried by the at least two inner fork prongs.

It may be the case that the at least two outer fork prongs are subsequently brought into contact with a given already picked up lower packaging blank, and the given packaging blanks to be tightly gripped are thereby carried by both the at least two inner fork prongs as well as the at least two outer fork prongs. In particular, the at least two inner fork prongs can, by an actuator, be brought into a position in which the at least two outer fork prongs are in a common plane with the at least two inner fork prongs.

Embodiments have proven to be useful in which the lower gripping unit is introduced into the stack of packaging blanks in the region of the raised outer edges and at least partially receives the given packaging blanks to be tightly gripped so that the given packaging blanks to be tightly gripped are completely or partially carried by the lower gripping unit. Furthermore, at least one centering element configured as a component of the gripper head can be moved and align the plurality of completely or partially picked-up packaging blanks flush with one another.

The gripper head may comprise at least one suction instrument via which the gripper head pneumatically receives a last packaging blank from the stack of packaging blanks formed up to then, whereupon the gripper head transports the pneumatically picked-up packaging blank in the direction of a predefined destination.

The invention also relates to a packaging system. The packaging system comprises a supply device for receiving at least one stack of flat packaging blanks. The packaging system further comprises a manipulator that possesses a gripper head with an upper gripping unit and a lower gripping unit which are configured for the joint tight gripping of a plurality of packaging blanks from a stack of packaging blanks picked up via the supply device.

It is provided that the supply device comprises a stop wall which is movable in such a way that the stop wall can be brought into surface contact with packaging blanks of a stack received by the supply device by a movement so that the given packaging blanks are aligned flush with one another. In particular, the stop wall may be configured to be movable in the horizontal direction.

In particular, the gripper head may comprise at least one fork prong which is configured in such a way that it can be moved into a free space formed by the pallet in order to pick up a pallet. This makes it easy also to manipulate pallets in addition to packaging blanks.

The packaging system may include a packaging device for packaging articles using packaging blanks. The packaging device can be located within a working range of the manipulator, wherein the manipulator is configured to transfer packaging blanks in each instance tightly gripped by its gripper head to the packaging device. The packaging device may be configured for packaging articles using packaging blanks, wherein the articles are beverage containers.

The supply device may comprise a hold-down device which can be placed on a stack of packaging blanks received by the supply device so that the stack is held by clamping to the supply device.

It is further conceivable that the supply device comprises a turntable configured to support the given received stack of packaging blanks, which turntable is configured to be rotatable about a vertically oriented axis.

The supply device may also comprise a pivoting device to which the hold-down device and a support surface of the supply device provided for the stack of packaging blanks are connected in such a way that the support surface and the hold-down device are rotatable about a common horizontally oriented axis by the pivoting device.

It may be that the supply device comprises a pivoting device to which the hold-down device and the turntable are connected in such a way that the turntable and the hold-down device are rotatable about a common horizontally oriented axis by the pivoting device.

The invention further relates to a packaging system with a supply device for receiving at least one stack of packaging blanks and a manipulator which possess a gripper head with an upper gripping unit and a lower gripping unit which are configured for the joint tight gripping of a plurality of packaging blanks from a stack of packaging blanks received via the supply device. The packaging system also includes a tray.

It is provided that the tray comprises a support surface for receiving packaging blanks via the manipulator, and the lower gripping unit of the manipulator comprises at least two fork prongs oriented parallel to one another, wherein the support surface forms at least one slot, the dimensioning of which is configured in such a way that the at least one fork prong can pass through the support surface via the at least one slot.

In particular, the gripper head may comprise at least one fork prong which is configured in such a way that it can be moved into a free space formed by the pallet in order to pick up a pallet. This makes it easy also to manipulate pallets in addition to packaging blanks.

The packaging system may include a packaging device for packaging articles using packaging blanks. The packaging device can be located within a working range of the manipulator, wherein the manipulator is configured to transfer packaging blanks in each instance tightly gripped by its gripper head to the packaging device. In various embodiments, the packaging device may be configured to package articles using packaging blanks, wherein the articles are beverage containers. In such embodiments, the support surface may be configured as a component of the packaging device.

In addition, the invention relates to a packaging system which comprises a supply device for receiving at least one stack of flat packaging blanks and a manipulator, wherein the manipulator possesses a gripper head with an upper gripping unit and a lower gripping unit which are configured for the joint tight gripping of a plurality of packaging blanks from a stack of packaging blanks received via the supply device. It is provided that the supply device comprises a centering device via which flat packaging blanks of the at least one stack can be aligned flush with one another.

The centering device may comprise at least one centering bar which is configured to carry out a feed movement in order to thereby align the packaging blanks of a stack received via the supply device flush with one another.

Furthermore, the packaging system may comprise at least three centering bars which are configured to carry out a feed movement in order to align the packaging blanks of a stack received via the supply device flush with one another.

The at least three centering bars may be in connection to an actuator in such a way that the at least three centering bars are raised together in the vertical direction or lowered together in the vertical direction when the actuator is actuated.

The packaging system may include a packaging device for packaging articles using packaging blanks. The packaging device can be located within a working range of the manipulator, wherein the manipulator is configured to transfer packaging blanks in each instance tightly gripped by its gripper head to the packaging device. The packaging device may be configured for packaging articles using packaging blanks, wherein the articles are beverage containers.

In particular, the gripper head may comprise at least one fork prong which is configured in such a way that it can be moved into a free space formed by the pallet in order to pick up a pallet. This makes it easy also to manipulate pallets in addition to packaging blanks.

### BRIEF DESCRIPTION OF THE FIGURES

Exemplary embodiments of the invention and their advantages are explained in more detail below with reference to the accompanying figures. The proportions of the individual elements relative to one another in the figures do not always correspond to the actual proportions, since some forms are simplified, while other forms are shown enlarged in relation to other elements for better illustration.

FIGS. 1A and 1B show schematic perspective views of an embodiment of a gripper head.

FIGS. 2A to 2C show schematic perspective views of a further embodiment of a gripper head.

FIGS. 3A to 3C show schematic perspective views of an embodiment of a separating unit, as may be provided as a component in various embodiments of a gripper head according to the invention and for implementation in various embodiments of the method according to the invention.

FIG. 4 shows a further embodiment of a separating unit as may be provided as a component in various embodiments of a gripper head according to the invention as well as for the implementation in various embodiments of the method according to the invention.

FIGS. 5A to 5G show steps as may be provided individually or according to the combination shown in FIGS. 5A to 5G in various embodiments of the method according to the invention.

FIG. 6 shows further aspects as may be provided in various embodiments of the method according to the invention.

FIGS. 7A to 7C show steps as may be provided individually or according to the combination shown in FIGS. 7A to 7C in further embodiments of the method according to the invention.

FIG. 8 shows a schematic perspective view of an embodiment of a packaging system according to the invention.

FIG. 9 shows a schematic view of a further embodiment of a packaging system according to the invention.

FIGS. 10A and 10B each show a schematic perspective view of a further embodiment of a gripper head according to the invention.

FIGS. 11A and 11B illustrate a procedure for transferring packaging blanks to a tray by a gripper head of the embodiment according to FIGS. 10A and 10B.

FIG. 12 shows an embodiment of a tray as may be provided in various

embodiments of a packaging system according to the invention as well as in various embodiments of the method according to the invention.

FIG. 13 shows a schematic view of an embodiment of a packaging system and a further embodiment of a gripper head according to the invention.

FIG. 14 shows further details as may be provided in various embodiments of the packaging system according to the invention and in various embodiments of the method according to the invention.

FIG. 15 shows a schematic view of a further embodiment of a gripper head according to the invention.

FIG. 16 shows a schematic view of a further embodiment of a packaging system according to the invention.

FIG. 17 shows the embodiment of a packaging system according to FIG. 16 in plan view.

FIGS. 18A to 18D show a schematic view of a further embodiment of a packaging system according to the invention.

FIGS. 19A and 19B show an exemplary embodiment of a supply device as may be provided in various exemplary embodiments of a packaging system according to the invention and when carrying out various exemplary embodiments of the method according to the invention.

FIG. 20 shows individual steps in the flow diagram as may be provided in various embodiments of the method according to the invention.

Identical reference numerals are used for identical elements of the invention or those having the same effect. Furthermore, for the sake of clarity, only reference signs are shown in the individual figures, which are required for the description of the respective figure. The illustrated embodiments are merely examples of how the invention can be designed, and are non-limiting.

### DETAILED DESCRIPTION OF THE INVENTION

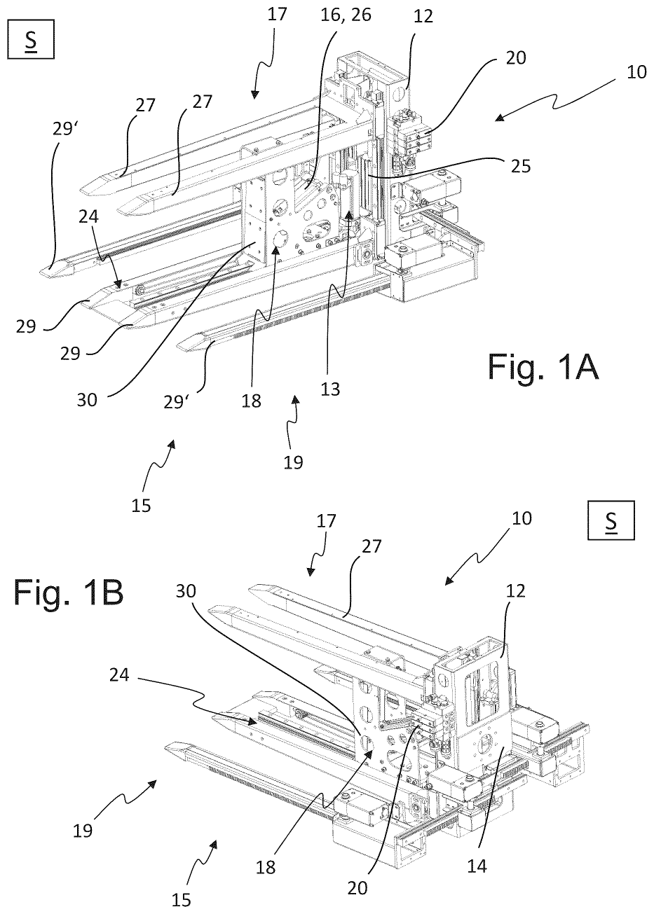

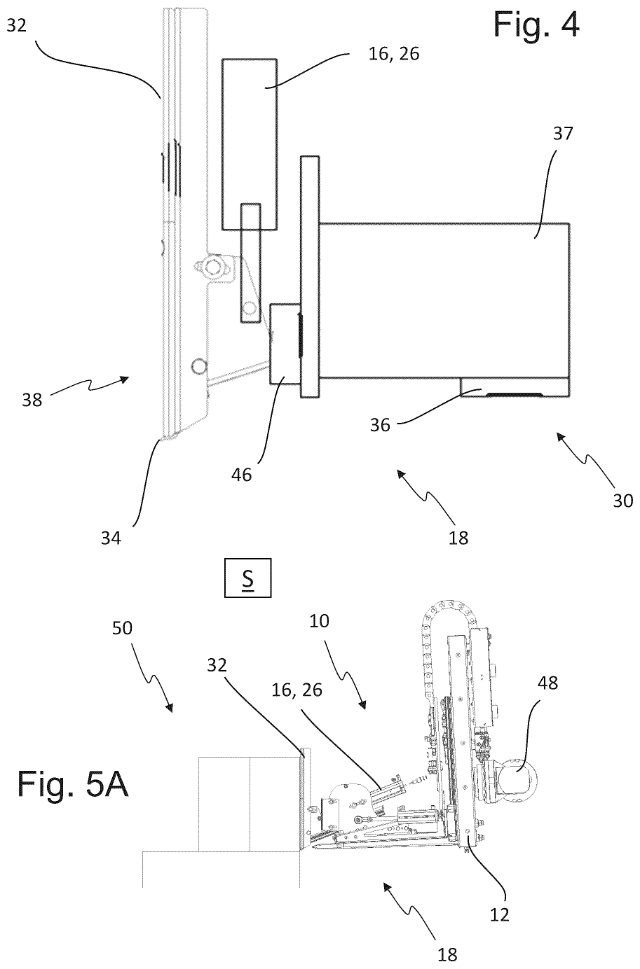

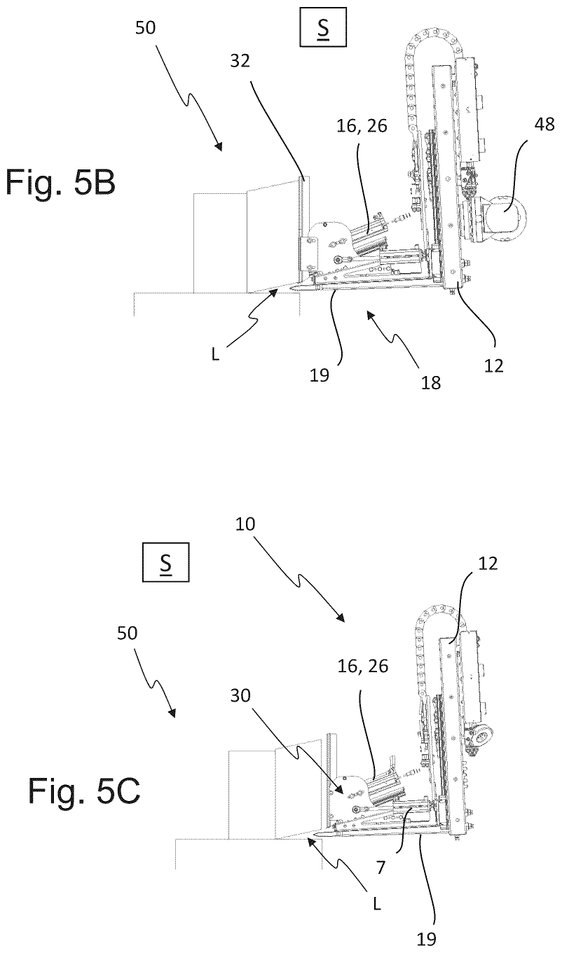

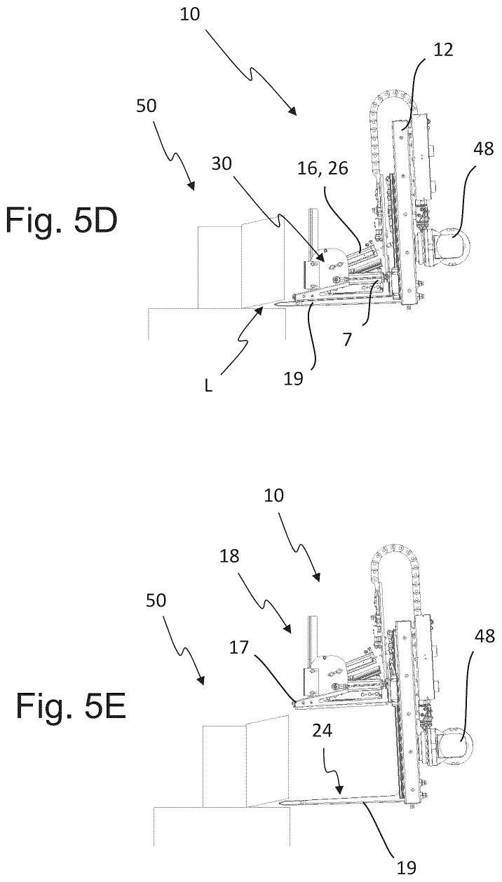

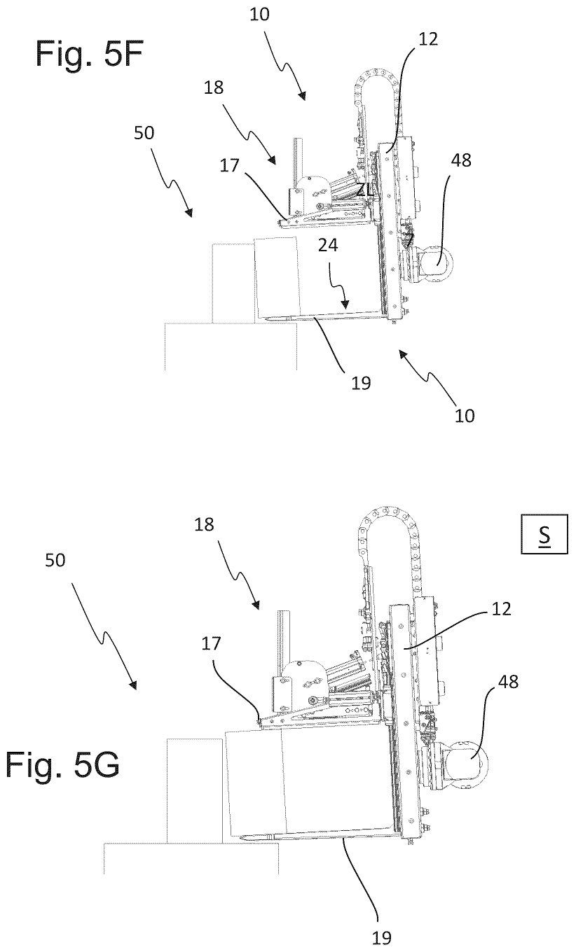

FIGS. 1A and 1B show schematic perspective views of an embodiment of a gripper head 10 that can be connected to a manipulator 1. The manipulator 1, which can carry a gripper head 10 according to the exemplary embodiment according to FIGS. 1A and 1B, is configured in practice, for example, as an articulated arm robot 1′. Such an articulated arm robot 1′ possesses a working arm 48 (see FIGS. 5A to 5G) to which the gripper head 10 is attached.

The gripper head 10 comprises a rack 12 which in this case may be a thin-walled, welded sheet metal part made of stainless steel or aluminum. For example, galvanized steel, titanium, lightweight materials, fiber composite materials and/or materials can be provided as other conceivable materials for the rack 12. The rack 12 may also be manufactured in various embodiments using a three-dimensional printing process.

As can be seen from FIG. 1B, a flange 14 is arranged on a rear side of the rack 12 via which the gripper head 10 can be attached to a manipulator 1 or to an articulated arm robot 1′. The flange 14 may be a quick-change system or a component of a quick-change system. Such systems have the advantage that the gripper head 10 can be quickly and easily removed from a working arm 48 of a manipulator 1 and can be quickly and easily arranged on a working arm 48 of a manipulator 1.

Also arranged on the rack 12 are tongs 15 which comprise an upper gripping unit 17 and a lower gripping unit 19. The upper gripping unit 17 possesses two first fork prongs 27 oriented parallel to one another. The lower gripping unit 19 possesses two inner fork prongs 29 oriented parallel to one another and two outer fork prongs 29′ oriented parallel to one another.

The gripper head 10 is adapted to adjust an orientation or inclination of the inner fork prongs 29 and the first fork prongs 27 along their given longitudinal axes. As a result, contact surfaces of the inner fork prongs 29 intended for packaging blanks can be aligned parallel to contact surfaces of the first fork prongs 27, thereby allowing secure receiving of packaging blanks.

Both the upper gripping unit 17 as well as the lower gripping unit 19 can be moved up and down in a linear direction along the rack 12 via a given pneumatic cylinder 25, of which only one pneumatic cylinder 25 can be seen in FIG. 1A. When the upper gripping unit 17 and the lower gripping unit 19 move toward one another, packaging blanks can be tightly gripped via the upper gripping unit 17 and the lower gripping unit 19.

When the given packaging blanks tightly gripped in this way have been transported to the given destination via the manipulator 1 or via the gripper head 10, the lower gripping unit 19 and the upper gripping unit 17 can increase their relative distance, whereby the packaging blanks are released. For this purpose, the pneumatic cylinder 25 is actuated again.

The gripper head 10 offers the possibility of specifying the given clamping force required for clamping packaging blanks by adjusting the pressure acting on the pneumatic cylinders 25 on the control and/or regulating device 20.

Furthermore, the gripper head 10 comprises a separating unit 18 which, in the embodiment according to FIGS. 1A and 1B, is configured as a component of the lower gripping unit 19. The separating unit 18 can, as will be described below, be moved along the inner fork prongs 29 of the lower gripping unit 19 in order to lift an outer edge of a lower packaging blank to be gripped.

To move the separating unit 18, the gripper head 10 comprises an actuator 13 and a carriage 30. The actuator 13 can move the carriage 30 back and forth along the inner fork prongs 29.

In order to lift the given outer edge of the given lower packaging blank to be gripped, the gripper head 10 comprises a linear actuator 16 which can be partially seen in FIG. 1A. The linear actuator 16 in this case is a pneumatic cylinder 26. The linear actuator 16 or the pneumatic cylinder 26 is connected to the carriage 30 so that the linear actuator 16 or the pneumatic cylinder 26 are moved back and forth together with the carriage 30 along the inner fork prongs 29.

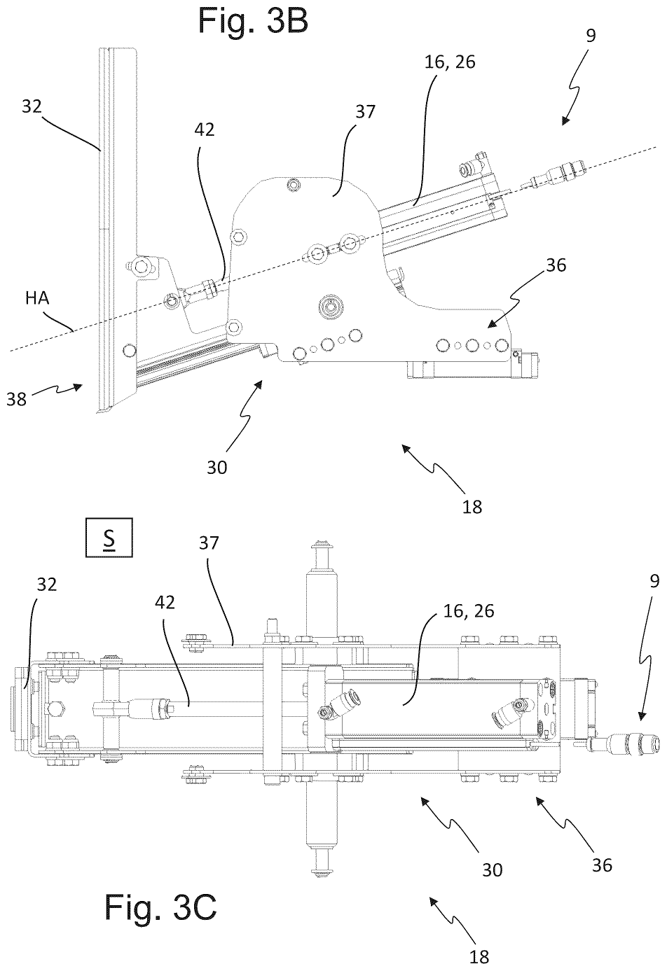

A rectilinear lifting axis HA (seen in. FIG. 3A) of the linear actuator 16 or the pneumatic cylinder 26 is inclined relative to a contact surface 24 for packaging blanks when the separating unit 18 lifts the given outer edge of the given lower packaging blank via the linear actuator 16. The contact surface 24 is formed by the lower gripping unit 19 or by the inner fork prongs 29 and by the outer fork prongs 29′ of the lower gripping unit 19. It lies flat against the given lower packaging blank when the given received packaging blanks are held in a clamped manner via the lower gripping unit 19 and the upper gripping unit 17.

As will be described below, embodiments have proven themselves in which the rectilinear lifting axis HA is inclined relative to the contact surface 24 at an angle which is between 5° and 30°, in particular between 10° and 25°, and preferably between 15° and 20°. In such embodiments, an outer edge of a lower packaging blank to be gripped can be lifted, while at the same time there is only a very small risk that the lower packaging blank to be received will unintentionally detach from the separating unit 18.

FIGS. 1A and 1B also show that the gripper head 10 has a control and/or regulating device 20 via which the gripper head 10 can be connected to a central controller S. The pneumatic supply or control of the gripper head 10 is carried out via the control and/or regulating device 20, for which purpose the central control S comprises a plurality of valves or can actuate a plurality of valves. Furthermore, the control and/or regulating device 20 forms an interface for a plurality of sensors formed as a component of the gripper head 10.

Because the gripper head 10 can thus preferably only be connected to the central control S via the control and/or regulating device 20, it is not necessary to lay a large number of lines to the central control S in order to be able to operate the gripper head 10. The coupling of the gripper head 10 is therefore carried out in a simple and uncomplicated manner. In addition, the gripper head 10 can be changed quickly and easily.

In practice, embodiments have proven successful in which the control and/or regulating device 20 provides an interface for almost all control elements, wherein only pneumatic and electrical supply lines and a data line are routed from the gripper head 10 to a switching cabinet.

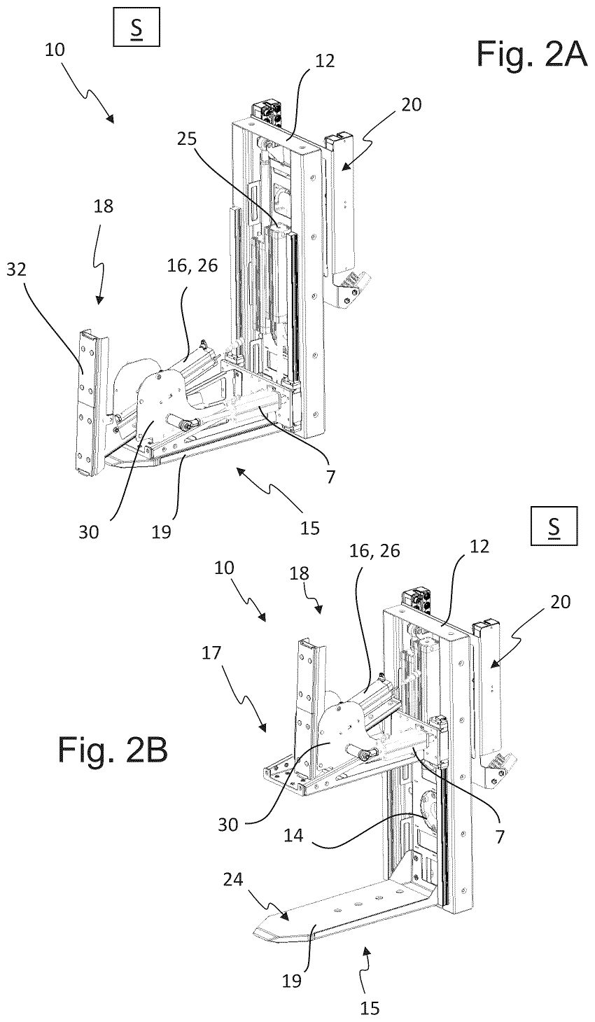

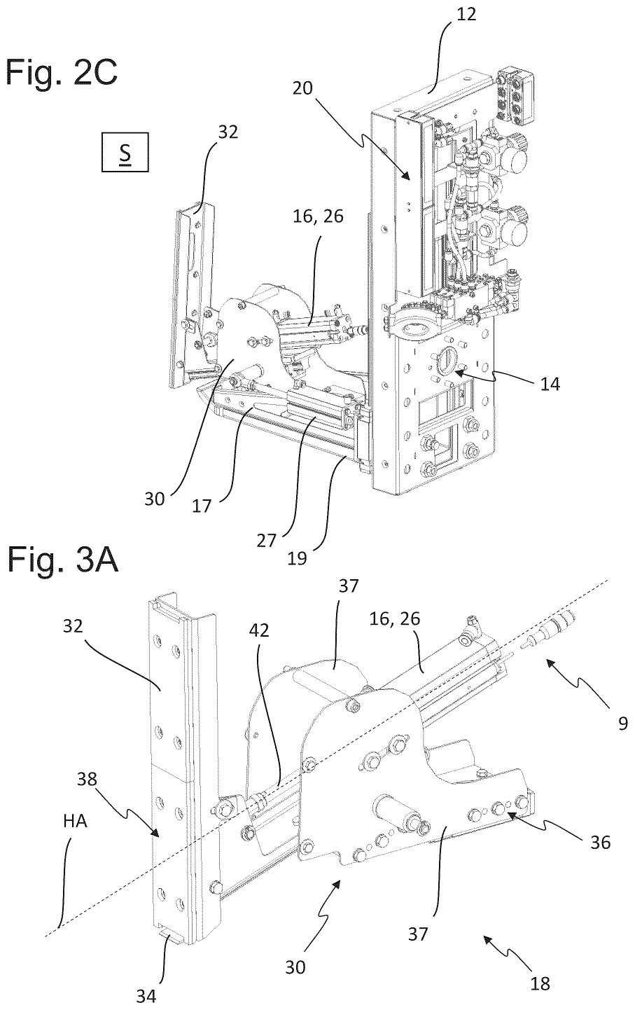

FIGS. 2A to 2C show schematic perspective views of a further embodiment of a gripper head 10 as it may be provided in various embodiments of a manipulator 1 according to the invention. The embodiment of a gripper head 10 according to FIGS. 2A to 2C also possesses tongs 15 with an upper gripping unit 17 and a lower gripping unit 19 via which the gripper head 10 can jointly pick up a plurality of packaging blanks from a stack 50 and tightly grip them.

The upper gripping unit 17 and the lower gripping unit 19 may be aligned with one another so that a contact surface of the upper gripping unit 17 intended for receiving packaging blanks and a contact surface 24 of the lower gripping unit 19 intended for receiving packaging blanks are oriented parallel or substantially parallel to one another.

In the embodiment according to FIGS. 2A and 2B, the lower gripping unit 19 is fixedly connected to the rack 12. On the other hand, the upper gripping unit 17 may be moved up and down along the rack 12 via the pneumatic cylinder 25, as can be seen from a comparison of FIG. 2A with FIG. 2B.

In the embodiment according to FIGS. 2A and 2B, the separating unit 18 is arranged on the upper gripping unit 17 or is configured as a component of the upper gripping unit 17 and is thus moved up and down together with the upper gripping unit 17. In the embodiment according to FIGS. 2A to 2C, the separating unit 18 also has a carriage 30 on which the linear actuator 16, which is a pneumatic cylinder 26, is arranged. The carriage 30 may be moved together with the linear actuator 16 along the upper gripping unit 19 via the pneumatic cylinder shown with reference sign 7.

A control and/or regulating device 20 is arranged on the rear side on the rack 12 which is connected to a central control S in accordance with the previous description of the exemplary embodiment according to FIGS. 1A and 1B. The control and/or regulating device 20 can be seen in detail in particular in FIG. 2C.

As FIG. 2C also shows, the rack 12 forms a flange 14 on its rear side which faces away from the tongs 15, via which flange the gripper head 10 can be attached to a manipulator 1. The flange 14 may also be configured as a component of a quick-change system in the embodiment according to FIGS. 2A to 2C.

An advantage of the embodiment according to FIGS. 2A to 2C compared to the embodiment according to FIGS. 1A and 1B is that a center of gravity of the gripper head 10 is located closer to the flange of the given manipulator 1 on which the gripper head 10 is arranged. This allows the gripper head 10 to also be used for smaller manipulators 1.

With the embodiment according to FIGS. 1A and 1B, very short cycle times or very high cycle rates can be achieved because the upper gripping unit 17 is only moved a small distance when a plurality of packaging blanks are jointly tightly gripped via the gripper head 10.

FIGS. 3A to 3C show schematic perspective views of an embodiment of a separating unit 18 as it may be provided as a component in various embodiments of a gripper head 10 according to the invention and for implementation in various embodiments of the method 100 according to the invention (seen in FIG. 31). The separating unit 18 according to the embodiment according to FIGS. 3A and 3B is configured as a component of the gripper head 10 of the previous exemplary embodiments according to FIGS. 1A, 1B and according to FIGS. 2A to 2C.

FIG. 3A shows once more in detail the linear actuator 16 which is a pneumatic cylinder 26. If a plurality of packaging blanks which are intended to be received via the gripper head 10 is to be lifted by the separating unit 18, a piston 42 of the pneumatic cylinder 26 is initially in an extended position.

The stop 32 and the projection 34 are connected to the piston 42 of the pneumatic cylinder 26. The given manipulator 1 then moves the gripper head 10 in the direction of the given packaging blanks to be tightly gripped, wherein the stop 32 comes into surface contact with these packaging blanks, and the projection 34 is introduced into the stack of packaging blanks so that the projection 34 is then located below the outer edge of a given lower packaging blank to be gripped.

The piston 42 of the linear actuator 16 or the pneumatic cylinder 26 then performs a return stroke movement along the lifting axis HA and thereby lifts the outer edge of the given lower packaging blank to be gripped. This return stroke movement is effected by bringing the stop 32 into surface contact with the packaging blanks still to be received and guiding the gripper head 1 together with the separating unit 18 in the direction of the given packaging blanks still to be received.

The packaging blanks still to be received thus forcefully come into surface contact with the stop 32 and thereby cause a return stroke movement of the piston 42. A pressure or working pressure of the pneumatic cylinder may be set via the aforementioned control and/or regulating device 20.

During the lifting movement, the lifting axis HA is inclined relative to the contact surface 24 (see FIGS. 1A and 2B) at an angle which is between 15° and 20° and which in particular is substantially 18°. This makes it possible to prevent the outer edge of the given lower packaging blank to be received from slipping off the projection 34 during lifting. The lifting of this outer edge via the separating unit 18 is carried out with high reliability at the described angle of the lifting axis HA.

In addition, FIGS. 3A to 3C again show the carriage 30 configured as a component of the separating unit 18. An interface via which the carriage 30 is connected to the upper gripping unit 17 or to the lower gripping unit 19 is shown in FIGS. 3A to 3C with reference to number 36. The carriage 30 has a rack 37 which may be made of thin-walled and welded stainless steel or aluminum sheet metal parts. In further embodiments, the rack 37 may also be formed by a fiber composite material.

The stop 32 possesses an anti-slip and elastically flexible surface 38 in order to avoid damage in the event of contact with the given packaging blanks to be tightly gripped. The projection 34 extends beyond the stop 32 so that the given packaging blanks to be tightly gripped can be securely held by the projection 34. In order to avoid damage to packaging blanks when the projection 34 plunges into the stack 50 of packaging blanks, the projection 34 tapers toward its free end or even comes to a point toward its free end.

The pneumatic cylinder 26 is assigned a displacement sensor 9 which supplies information to the control and/or regulating device 20 of the gripper head 10 with which information about the given stroke of the piston 42 can be determined. When the separating unit 18 aligns packaging blanks flush with one another via the stop 32, the stop 32 is slightly inclined in the direction opposite these given packaging blanks.

The schematic representation of FIG. 4 shows a further embodiment of a separating unit 18 as it may be provided as a component in various embodiments of a gripper head 10 according to the invention and for implementation in various embodiments of the method 100 according to the invention (seen in FIG. 31).

The embodiment of the separating unit 18 according to FIG. 4 also comprises a carriage 30 which forms a rack 37. The rack 37 consists of thin-walled, welded sheet metal parts made of stainless steel or aluminum. Alternatively thereto, the rack 37 may be made of a fiber composite material. The stop 32 corresponds to the embodiment already described previously in FIGS. 3A to 3C and comprises an anti-slip and elastic surface 38.

The interface with the upper gripping unit 17 or the lower gripping unit 19 is further illustrated with reference to item 36. The linear actuator 16, which is also a pneumatic cylinder 26, differs in orientation and arrangement from the embodiment of a separating unit 18 according to FIGS. 3A to 3C. The lifting axis HA of the pneumatic cylinder 26 is oriented substantially perpendicular to the previously described contact surface (seen in FIG. 1A) when the separating unit 18 lifts an outer edge of a given lower packaging blank to be received. Instead of the pneumatic cylinder 26, an electric actuator or a hydraulic actuator may also be used for the linear actuator 16.

FIGS. 5A to 5G show steps as they may be provided individually or according to the combination shown in FIGS. 5A to 5G in various embodiments of the method 100 according to the invention. The method 100 is carried out by a gripper head 10 as previously shown and described in the exemplary embodiment according to FIGS. 2A to 2C.

The gripper head 10 is arranged on a working arm 48 of a manipulator 1. The manipulator 1 in this case is an articulated arm robot 1′. The working arm 48 can only be seen partially in FIGS. 5A to 5G.

In FIG. 5A, the gripper head 10 was moved by the working arm 48 in the direction of packaging blanks of the stack 50 to be picked up so that the stop 32 forcefully came into surface contact with the given packaging blanks to be picked up. Behind the packaging blanks to be picked up, there is a stop wall 5 which is not shown in FIG. 5A but is shown, for example, in FIG. 9. After the stop 32 contacts the given packaging blanks to be picked up, the manipulator 1 or the gripper head 10 presses the packaging blanks to be picked up against this stop wall 5, whereby the given packaging blanks to be picked up are aligned flush or substantially flush with one another.

In addition, the projection 34 is introduced into the stack 50 by the movement of the gripper head 10 in the direction of the packaging blanks to be picked up so that in FIG. 5A, an outer edge of a lower packaging blank to be picked up already rests on the projection 34. The piston 42 (see FIGS. 3A to 3C) is in an extended position in FIG. 5A.

The method step according to FIG. 5B follows the method step according to FIG. 5A. Starting from FIG. 5A, the piston 42 of the pneumatic cylinder 26 performs a return stroke movement. The return stroke movement is carried out due to a force with which the packaging blanks to be picked up act on the pneumatic cylinder 26 during a gripper head 10 movement which is oriented in the direction of the stack 50. A contact force with which in this case the pneumatic cylinder 26 or the piston 42 holds the packaging blanks to be picked up may be set or predefined on the control and/or regulating device 20 (see FIGS. 1A and 1B and FIGS. 2A and 2B).

When the rack 12 moves in the direction of the stack 50, a given outer edge of the packaging blanks to be picked up is raised above the separating unit 18 relative to the packaging blanks remaining on the stack 50, whereby a gap L is created.

The lifting axis HA (see FIGS. 3A and 3B) of the pneumatic cylinder 26 is in this case inclined relative to a contact surface 24 formed by the lower gripping unit 19 at an angle which is substantially 18°. Simultaneously with the return stroke movement, the stop 32, together with the projection 34 and the packaging blanks standing upright on the projection 34, is displaced in the direction of the rack 12 and in so doing initially remains in surface contact with the outer edges of the given packaging blanks that are still to be tightly gripped.

As previously mentioned, lifting the outer edges causes a gap L to arise into which the lower gripping unit 19 can plunge. In FIG. 5B, the lower gripping unit 19 is already located in the gap L. When the gap L is formed and the lower gripping unit 19 is plunged into the gap L according to FIG. 5B, the piston 42 (seen in FIGS. 3A to 3C) can perform an active return stroke movement, whereby the stop 32 leaves the packaging blanks, and the projection 34 is pulled off the packaging blanks. The movement of the piston 42 is monitored over the course of the return stroke movement via the position sensor 9 (see FIG. 3A) of the separating unit 18. The return stroke movement can be controlled if an actual position of the piston 42 deviates from a predefined target position during the return stroke movement.

As already mentioned above, the return stroke movement of the piston 42 of the pneumatic cylinder 26 is initially effected by the contact force of the packaging blanks to be picked up when the rack 12 is moved in the direction of the stack 50. Once the piston 42 has reached a specific position, this specific position is detected, and the described active return stroke movement is effected for the piston 42, whereby the stop 32 leaves the packaging blanks, and the projection 34 is pulled off the packaging blanks.

Because the lower gripping unit 19 is still located in the gap L, the gap L is maintained. The lower gripping unit 19 comes into contact with the given lower packaging blank during or after the return stroke movement of the projection 34. The given packaging blanks to be picked up by being clamped then rest on the lower gripping unit 19.

This method step is shown in FIG. 5C, wherein the stop 32 has already been retracted via the pneumatic cylinder 26 and, in FIG. 5C, has lost its surface contact with the given packaging blanks, which given packaging blanks are subsequently still tightly gripped via the gripper head 10.

As may be seen from a comparison of FIG. 5C to FIG. 5D, the pneumatic cylinder 7 also performs a return stroke movement, whereby the carriage 30, together with the pneumatic cylinder 26, the stop 32 and the projection 34, is retracted in the direction of the rack 12. The packaging blanks provided for being tightly gripped remain on the lower gripping unit 19 during the return stroke movement.

In step 5E, the pneumatic cylinder 25 (see FIG. 2A) of the gripper head 10 is actuated, and the upper gripping unit 17 is raised relative to the lower gripping unit 19. The gripper head 10 is moved from the position according to FIG. 5E to the position according to FIG. 5F via the working arm 48, whereby the lower gripping unit 19 plunges further into the gap L until the given packaging blanks which are to be tightly gripped via the gripper head 10 are completely carried by the lower gripping unit 19 of the gripper head 10.

Subsequently, the upper gripping unit 17 is moved via the pneumatic cylinder 25 (seen in FIG. 2A) in the direction of the lower gripping unit 19 until the upper gripping unit 17 comes into contact with a given upper packaging blank, and the given packaging blanks are held with a predefined clamping force between the upper gripping unit 17 and the lower gripping unit 19.

In FIG. 5G, the packaging blanks are tightly gripped via the upper gripping unit 17 and the lower gripping unit 19. As shown in FIG. 5G, it may be sufficient if the lower gripping unit 19 in FIG. 5F only plunges into the gap L up to such a position at which the upper gripping unit 17 only comes into contact with a partial region of the upper packaging blank during tight gripping. It is therefore not necessary for the lower gripping unit 19 to plunge into the gap L up to a position at which the given packaging blanks to be tightly gripped are already located in the proximity of the rack 12.

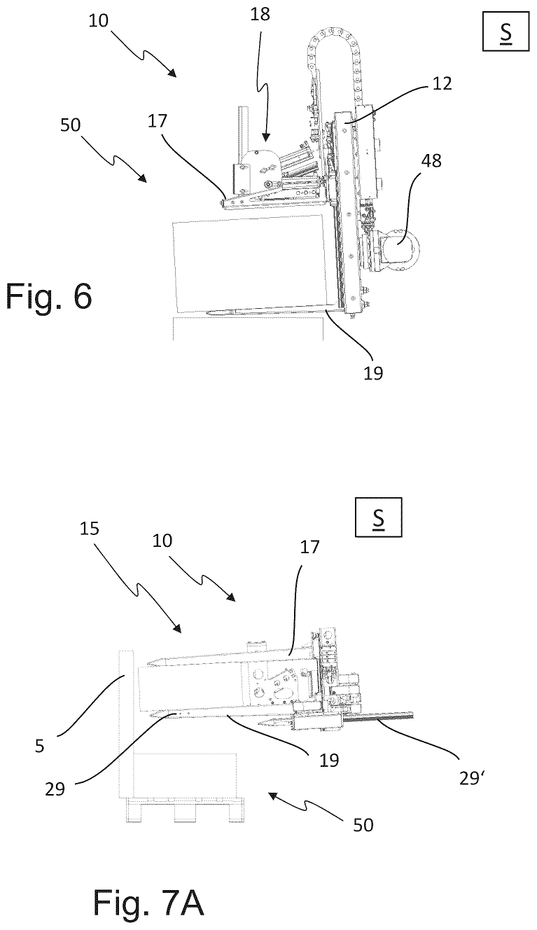

The schematic representation of FIG. 6 shows further aspects as may be provided in various embodiments of the method 100 according to the invention. In particular, FIG. 6 shows packaging blanks to be clamped in reception that differ in terms of their dimensions from the packaging blanks according to FIGS. 5A to 5G. The lower gripping unit 19 is still inserted into the gap L for clamping reception, but with a greater plunge depth compared to the embodiment according to FIGS. 5A to 5G. This allows a secure clamping reception even in the case of packaging blanks having larger dimensions when the upper gripping unit 17 and the lower gripping unit 19 subsequently carry out a feed movement.

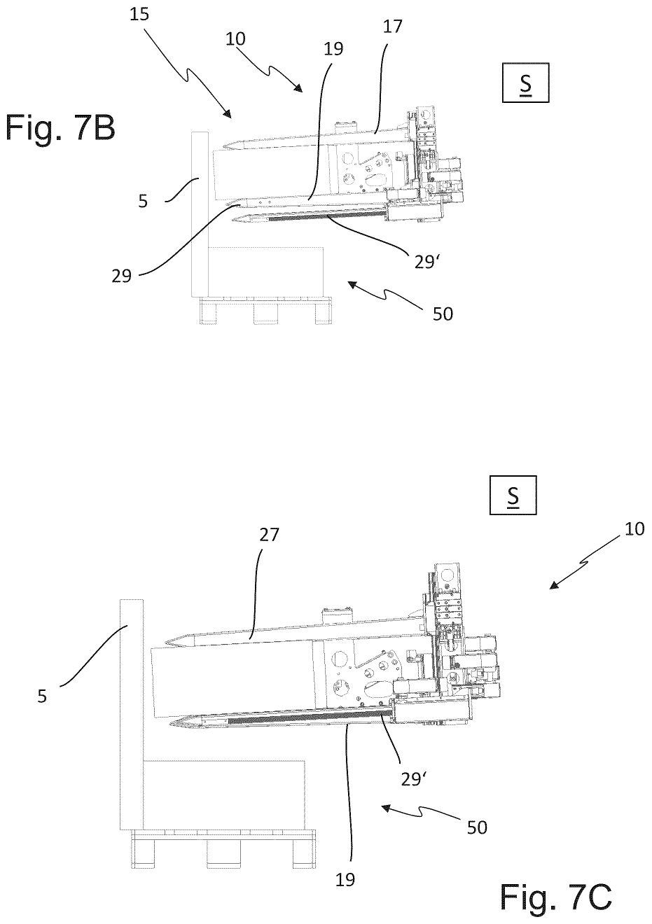

FIGS. 7A to 7C show steps as they may be provided individually or according to the combination shown in FIGS. 7A to 7C in further embodiments of the method 100 according to the invention. The method 100 is carried out by a gripper head 10 as it was previously shown and described in the exemplary embodiment according to FIGS. 1A and 1B.

In FIG. 7A, the gripper head 10 has already clamped in reception a plurality of packaging blanks from the stack 50. In FIG. 7A, the upper gripping unit 17 and the lower gripping unit 19 are in forceful contact with the packaging blanks clamped in reception. Before the clamping reception shown in FIG. 7A, a given outer edge of the packaging blanks still to be received was lifted by the separating unit 18 and a gap L was formed, as has already been mentioned and described for the embodiment according to FIGS. 5A to 5G.

In FIGS. 7A to 7C, the packaging blanks clamped in reception protrude in the direction of the image plane and in the direction opposite the image plane beyond the inner fork prongs 29 configured as part of the lower gripping unit 19. In order to be able to hold the packaging blanks clamped in reception stable during further manipulation, outer fork prongs 29′ are brought into contact with the given part of the lower packaging blank clamped in reception that protrudes in the direction of the image plane and in the direction opposite the image plane. In FIGS. 7A to 7C, only one outer fork prong 29′ of these two outer fork prongs 29′ can be seen because the further outer fork prong 29′ is covered by the outer fork prong 29′ shown in FIGS. 7A to 7C. Both outer forks are shown in FIGS. 1A and 1B.

From a comparison of FIG. 7A with FIG. 7B, it can be seen that the outer fork prongs 29′ are first moved along their longitudinal axis until the outer fork prongs 29′ are located at a predefined position below the packaging blanks that have already been clamped in reception, as shown in FIG. 7B. In this case, the relative distance between the outer fork prongs 29′ may be increased, or the outer fork prongs 29′ may be moved apart.

A further step is illustrated by a comparison of FIG. 7B with FIG. 7C. From the position according to FIG. 7B, the first fork prongs 27 and the inner fork prongs 29 are jointly lowered until the outer fork prongs 29′ come into contact with the packaging blanks that have already been clamped in reception. In FIG. 7C, portions of the packaging blanks protruding beyond the inner fork prongs 29 in the direction of the image and opposite the direction of the image are supported by the outer fork prongs 29′.

If a manipulator 1 transports the gripper head 10 together with the packaging blanks clamped in reception to a transport location in a subsequent step, the risk that packaging blanks will unintentionally detach from the gripper head 10 is very low. In addition, the described procedure prevents packaging blanks that are clamped in reception from sagging, which in turn can have a negative effect on their manipulation. By preventing such sagging, the risk of packaging blanks clamped in reception being damaged, and in particular being bent over the course of transport to the place of delivery can be reduced or even eliminated.

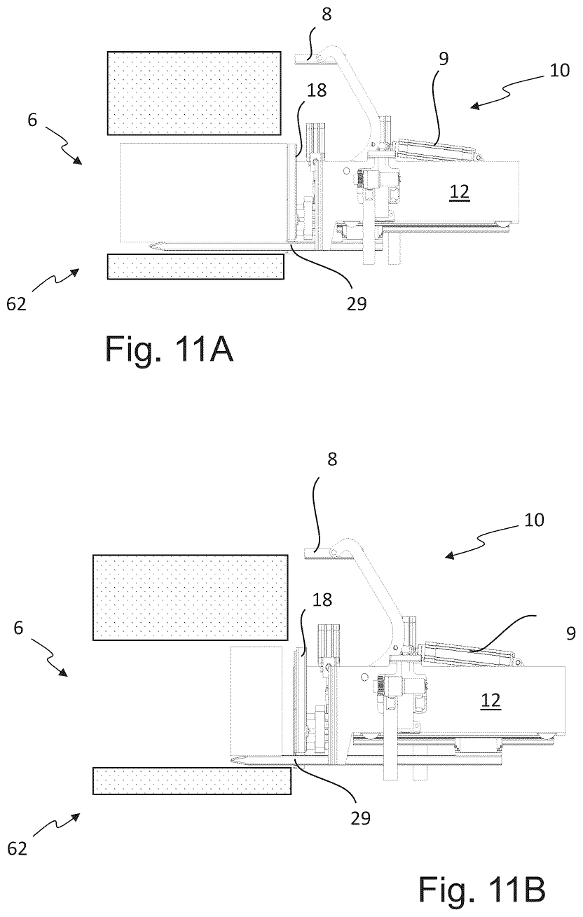

In addition, the described procedure ensures a high level of process reliability during the subsequent positioning of the packaging blanks clamped in reception at the destination at which a tray 62 can be located. The described procedure has also proven itself when the packaging blanks clamped in reception are to be inserted into a space-limited cutout which may be formed, for example, by an opening 6 (seen in FIG. 11A). In addition or as an alternative to the described embodiment, the outer fork prongs 29′ may be raised until the outer fork prongs 29′ come into contact with the packaging blanks already clamped in reception.

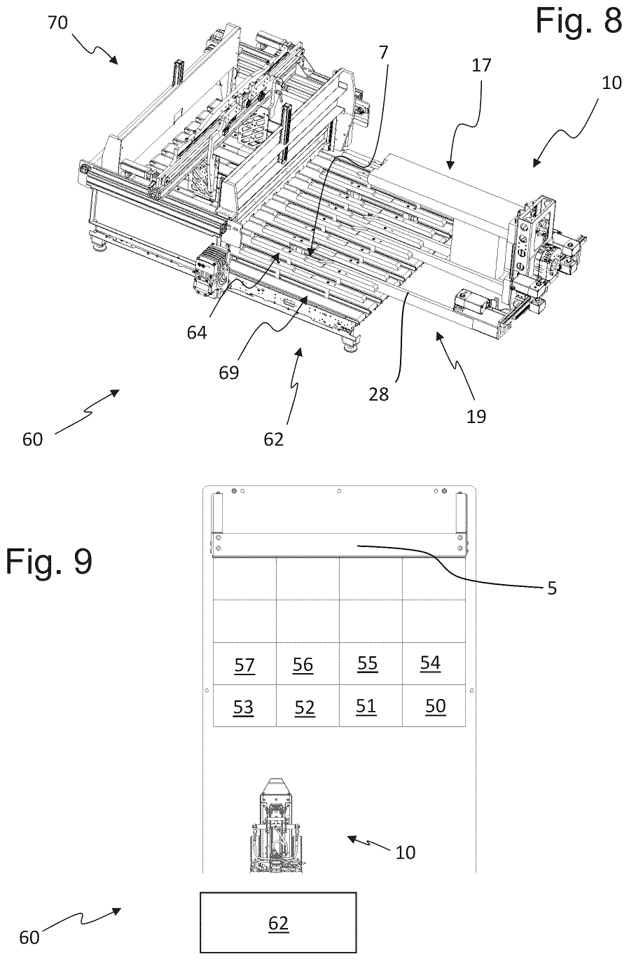

FIG. 8 shows a schematic perspective view of an embodiment of a packaging system 60 according to the invention. The packaging system 60 comprises a manipulator 1 (not shown in FIG. 8) which is configured as an articulated arm robot 1′ and carries a gripper head 10. The gripper head 10 possesses an upper gripping unit 17 and a lower gripping unit 19 which may each carry out a feed movement for tightly gripping a plurality of packaging blanks.

The packaging system comprises a tray 62 which forms a support surface 64. The manipulator 1 can place the given tightly gripped packaging blanks onto the support surface 64 via the gripper head 10. As may be seen from FIG. 8, the lower gripping unit 19 of the gripper head 10 comprises two fork prongs 28 oriented parallel to one another. If a plurality of packaging blanks are tightly gripped by the gripper head 10, the given plurality of packaging blanks stand upright on the fork prongs 28. The support surface 64 of the tray 62 forms a plurality of slots 7, the given width of which corresponds to the fork prongs 28 in such a way that the fork prongs 28 can pass through the support surface 64 via the slots 7. This allows a plurality of packaging blanks to be placed quickly and easily on the support surface 64 via the gripper head 10.

A given slot 7 is formed in the tray 62 between two directly adjacent conveyor belts 69. In various embodiments, it is conceivable that the tray 62 possesses a plurality of strips which are moved in the direction of the gripper head 10 in order to receive the given plurality of tightly gripped packaging blanks from the gripper head 10.

The given received packaging blanks are moved via the tray 62 or via the conveyor belts 69 formed as part of the tray 62 to a centering device 70 which flushly aligns the plurality of packaging blanks. From there, the packaging blanks are transported further and items, which are beverage containers, are packed using the packaging blanks. The centering device and the tray 62 are thus configured as a component of a packaging device not fully shown in FIG. 8, which packaging device in turn forms a component of the packaging system 60.

The embodiment of a gripper head 10 is to be understood in FIG. 8 merely as an example. It is also conceivable that the gripper head 10 of the packaging system 60 comprises a plurality of inner fork prongs 29 and a plurality of outer fork prongs 29′, as has already been shown in the exemplary embodiment according to FIGS. 1A and 1B, and which plurality of inner fork prongs 29 and/or which plurality of outer fork prongs 29 can be moved through the support surface 64 of the tray 62 via the slots 7.

FIG. 9 shows a schematic view of a further embodiment of a packaging system 60 according to the invention. With regard to reference sign 10, FIG. 9 also shows a gripper head which can jointly tightly grip a plurality of packaging blanks. In FIG. 9, a stack 50 of packaging blanks and a plurality of further stacks 51 to 57 of packaging blanks are shown.

FIG. 9 in particular illustrates a sequence in which the gripper head 10 receives a plurality of packaging blanks and places them on the tray 62. In this case, the gripper head 10 starts with the plurality of packaging blanks of the stack 50 and moves this plurality of packaging blanks to the tray 62. The gripper head 10 then continues to remove the given further plurality of packaging blanks from the stacks 51 to 57 in continuous sequence.

The gripper head 10 comprises a separating unit 18 with a stop 32 as it was already shown in the exemplary embodiment according to FIGS. 3A to 3C. Via the stop 32, the gripper head 10 presses the given plurality of packaging blanks yet to be tightly gripped in the direction of the stop wall 5, wherein the given packaging blanks are aligned flush with one another.

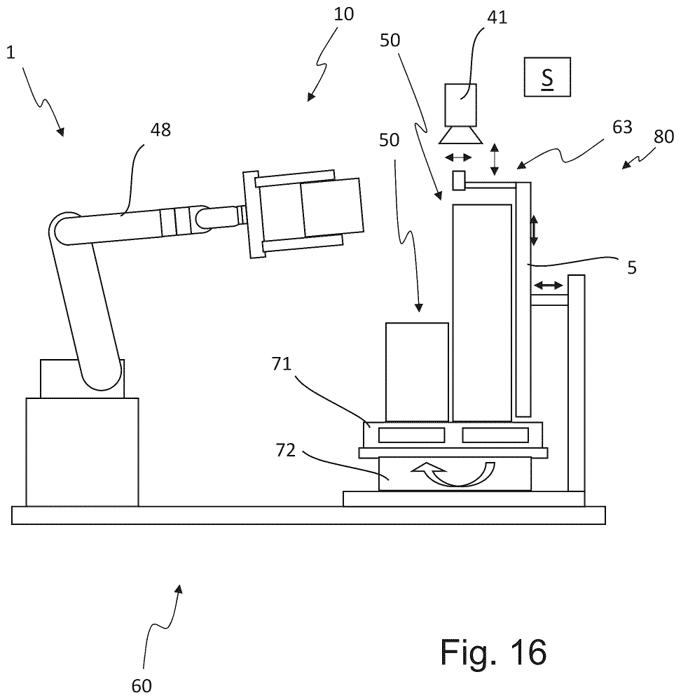

Further packaging blanks from further stacks 51 to 57 can be pressed in the downward direction by a hold-down device 63 (seen in FIG. 16), wherein such a hold-down device rests on a given packaging blank arranged on top of the given further stack 51 to 57. For example, the gripper head 10 may first receive the given plurality of packaging blanks from the stack 50 and the further stacks 51 to 53 in cycles and in each instance place them on the tray 62. The hold-down device 63 can press the given plurality of packaging blanks of the further stacks 54 to 57 in a downward direction.

When the gripper head 10 then begins to receive the plurality of packaging blanks from the stack 54, the hold-down device 63 can be displaced in the direction of a further row of stacks toward the stop wall 5 and press these packaging blanks in a downward direction. The movement or position of the hold-down device 63 can thus in each instance be coordinated with the receipt of packaging blanks via the gripper head 10.

Because the plurality of packaging blanks of different stacks 50 to 57 in practice lie close to one another or are in surface contact with one another, it is possible that packaging blanks of adjacent stacks 51 to 57 may unintentionally become entangled with one another when the gripper head 10 receives the given plurality of packaging blanks and moves them to the tray 62. It has therefore proven to be useful if the gripper head 10 moves the given plurality of packaging blanks diagonally away from the given stack 50 to 57 when the gripper head 10 removes the given plurality of packaging blanks from the given stack 50 to 57. This can minimize the risk of packaging blanks accidentally becoming entangled with one another.

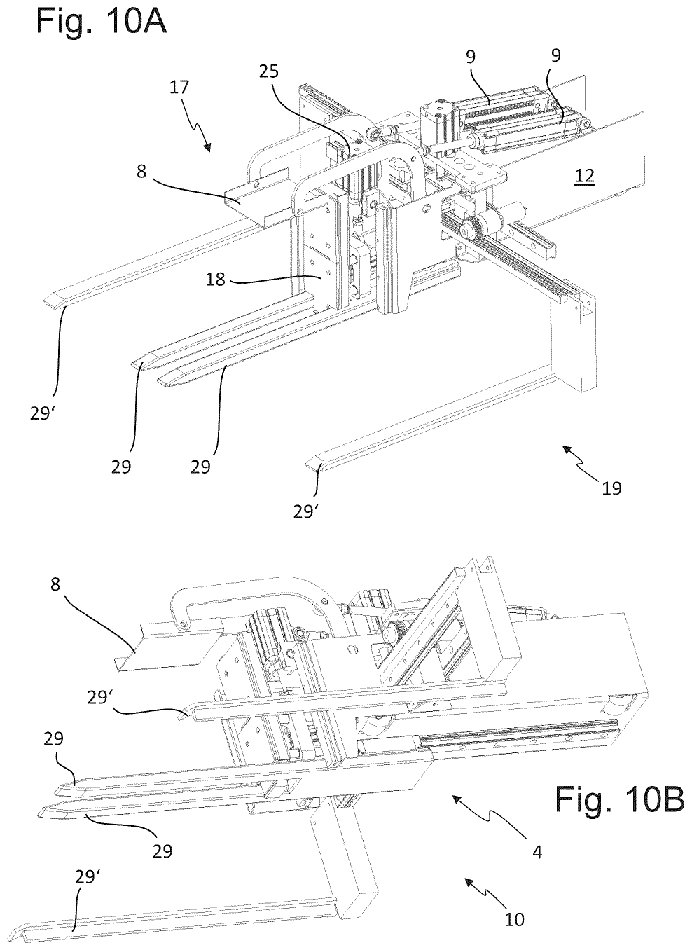

FIG. 10A shows a schematic perspective view of a further embodiment of a gripper head 10 according to the invention. The gripper head 10 comprises a rack 12 which is formed by a plurality of sheet metal parts welded together. The lower gripping unit 19 can be raised and lowered via a pneumatic cylinder 25. The gripper head 10 also comprises a separating unit 18 via which the outer edges of the given packaging blanks to be tightly gripped can be lifted.

The separating unit 18 is movable by actuator along the inner fork prongs 29. The upper gripping unit 17 comprises a sheet metal part 8. By actuating the piston-cylinder units 9, the sheet metal part 8 can be pivoted, placed on a packaging blank arranged at the top and already picked up by the inner fork prongs 29, and the plurality of packaging blanks already picked up can be tightly gripped to the gripper head 10.

FIG. 10B shows the gripper head 10 of the embodiment according to FIG. 10A from below. As can be seen herein, the gripper head 10 comprises a linear guide 4 along which linear guide 4 the inner fork prongs 29 of the gripper head 10 can move. A direction of movement in this case runs parallel to the given longitudinal extension of the inner fork prongs 29 and parallel to the longitudinal extension of the outer fork prongs 29′. By such a movement, the inner fork prongs 29 can be inserted into a stack 50 of packaging blanks via a gap L formed by the separating unit 18 as it has already been described for the embodiment according to FIGS. 5a to 5g.

Compared to the exemplary embodiments already described, it is thus possible to pick up a plurality of packaging blanks by the gripper head 10 according to FIGS. 10A and 10B without the gripper head 10 itself having to be moved via a working arm 48 of a manipulator 1 in order to plunge the inner fork prongs 29 into a gap L.

FIGS. 11A and 11B illustrate further advantages of the embodiment of a gripper head 10 according to FIGS. 10A and 10B. The given packaging blanks have already been tightly gripped by the gripper head 10. FIGS. 11A and 11B illustrate a transfer of the packaging blanks to a tray 62.

As shown in FIGS. 11A, the plurality of packaging blanks can be brought into contact with the separating unit 18 after being picked up via the inner fork prongs 29 by moving the inner fork prongs 29 along the linear guide 4 in the direction of the rack 12. In order to tightly hold the packaging blanks to the gripper head 10, it is sufficient if the sheet metal part 8 is forcefully placed on an upper packaging blank only in a small region that is located close to the separating unit 18.

In the exemplary embodiment according to FIGS. 11A and 11B, the tray 62 forms an opening 6 into which the packaging blanks are to be introduced via the gripper head 10.

The opening 6 is dimensioned in such a way that the gripper head 10 cannot be moved completely into the opening 6 in order to transfer the packaging blanks to the tray 62. Before a transfer, the sheet metal part 8 is first pivoted in the upward direction via the pneumatic cylinder 9, whereby it reaches a waiting position which is shown in FIGS. 11A and 11B. Such a movement of the sheet metal part 8 allows the gripper head 10 to be moved very close to the opening 6 in order to subsequently transfer the packaging blanks to the tray 62.

The packaging blanks can be introduced into the opening 6 by moving the gripper head 10 over the working arm 48 of the manipulator 1 until all the packaging blanks to be transferred to the tray 62 are in the opening. Alternatively or in addition, the inner fork prongs 29 may be extended or moved along the linear guide 4, wherein the packaging blanks enter the opening 6. When the packaging blanks are located in the opening 6, the packaging blanks are set down, whereupon the gripper head 10 is moved in the direction of a stack 50 (not shown in FIGS. 11A and 11B) for clamping reception of further packaging blanks.

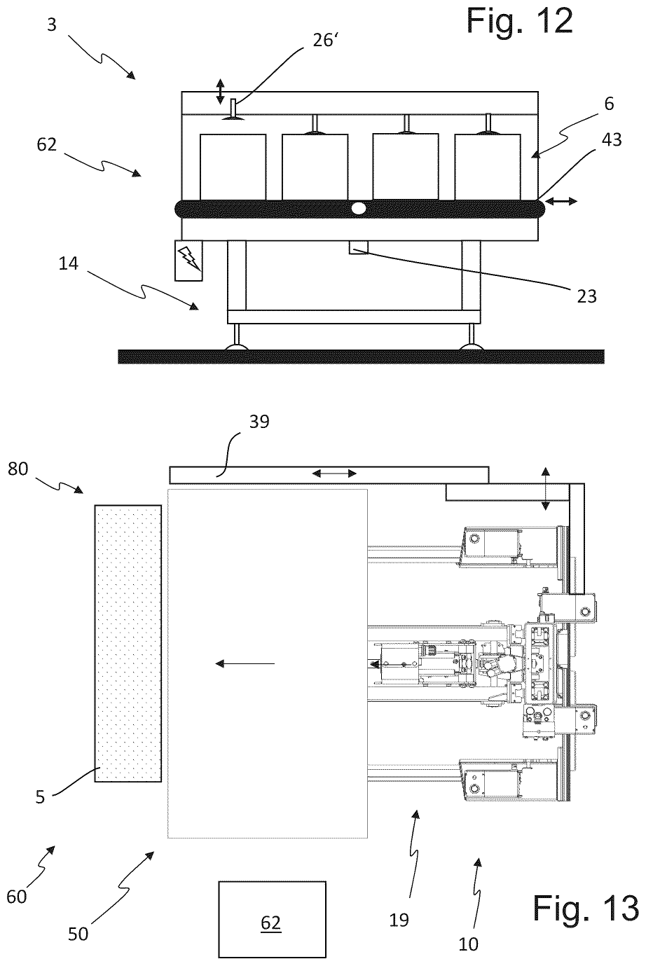

FIG. 12 shows an embodiment of a tray 62 as it may be provided in various embodiments of a packaging system 60 according to the invention as well as in various embodiments of the method 100 according to the invention. In the present case, the tray 62 is configured as a component of an adapter 3 and stands upright on a support frame 14 or is supported by a support frame 14. An opening 6 in the adapter 3 is configured in such a way that a complete gripper head 10 cannot be moved into the opening 6. In order to transfer packaging blanks to the tray 62 or to the adapter 3, an embodiment of a gripper head 10 as previously shown and described in FIGS. 10A and 10B and 11A and 11B in particular is therefore suitable.

The adapter 3 possesses a plurality of clamping device 26′ which can be placed on a given upper packaging blank in order to hold the given plurality of packaging blanks securely on the tray 62. In addition, the adapter 3 possesses a coupling 23 via which the adapter 3 can be coupled to a driverless transport vehicle or to an AGV so that the adapter 3 is supplied with electrical energy and, if necessary, also with compressed air from the driverless transport vehicle or the AGV via the coupling 23. Reference sign 43 refers to a mat strip by which the adapter 3 can transport already picked up packaging blanks and, if required, transfer them to a further device. The direction of movement is indicated by the depicted arrow in FIG. 12.

FIG. 13 shows a schematic view of an embodiment of a packaging system 60 and a further embodiment of a gripper head 10 according to the invention. The shown packaging system 60 comprises a supply device 80 via which a stack 50 of packaging blanks is provided. In the region of the stack 50, there is a stop wall 5 of the supply device 80.

Before the gripper head 10 picks up the given plurality of packaging blanks, the given plurality of packaging blanks are pressed against the stop wall 5 of the supply device 80 via the stop 32 of the separating unit 18 (seen in FIGS. 3A to 3C), wherein the front and rear edges of the given packaging blanks to be picked up are aligned flush with one another. In order to flushly align the lateral outer edges of the given packaging blanks to be picked up, the gripper head 10 comprises two centering elements 39 of which only one centering element 39 is shown in FIG. 13.

The centering element 39 can be moved in a linear direction and aligns the lateral outer edges of the given packaging blanks still to be completely picked up flush with one another. In FIG. 13, the packaging blanks of the stack 50 to be picked up are only partially arranged on the lower gripping unit 19.

After tightly gripping of the packaging blanks, the outer edges of which were previously aligned flush with one another, the gripper head 10 transfers the given packaging blanks to the tray 62 which is only shown schematically in FIG. 13. The tray 62 may be a component of a packaging device which packages beverage containers using the received packaging blanks.

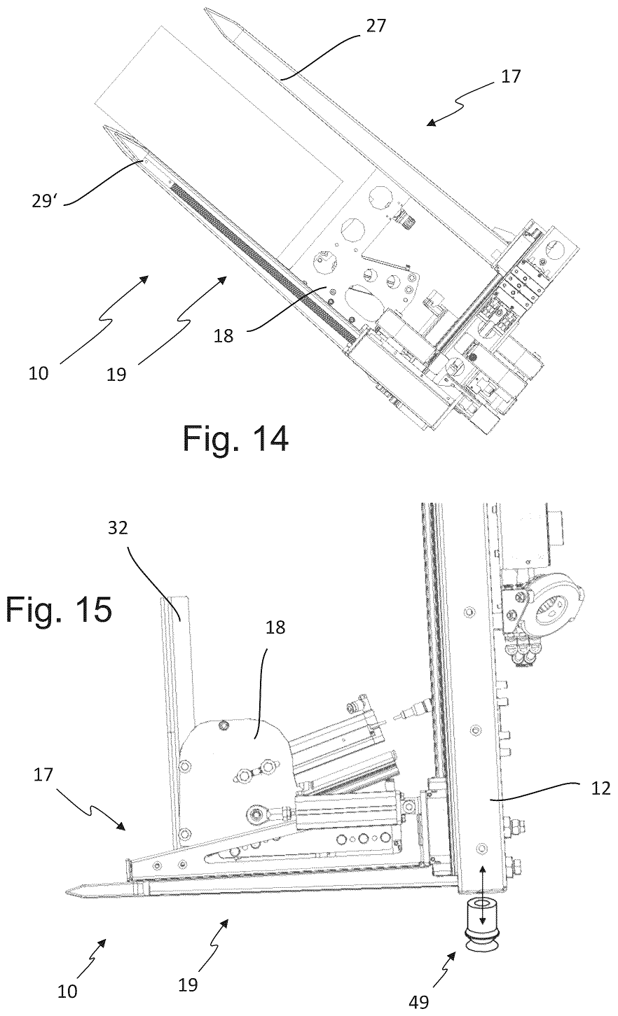

FIG. 14 shows further details as may be provided in various embodiments of the packaging system 60 according to the invention and in various embodiments of the method 100 according to the invention. In particular, FIG. 14 illustrates a possibility with which the plurality of packaging blanks already picked up by the gripper head 10 in FIG. 14 can be aligned flush with one another.

In FIG. 14, the gripper head 10 is connected to a manipulator 1 (not shown). After picking up the plurality of packaging blanks, the upper gripping unit 17 and the lower gripping unit 19 are moved apart from each other so that the upper gripping unit 17 and the lower gripping unit 19 thereby reach the position according to FIG. 14. The gripper head 10 is then rotated via the manipulator 1 in such a way that the picked-up packaging blanks slide against the separating unit 18 due to gravity, whereby outer edges of this plurality of packaging blanks are aligned flush with one another.

A gripper head 10 according to the embodiment of FIG. 14 may also comprise centering elements 39 as previously shown and described with regard to FIG. 13, and via which centering elements 39 lateral outer edges of the given plurality of picked-up packaging blanks can additionally be aligned flush with one another. In this case, the gripper head 10 may also be rotated about an axis that runs parallel to the first fork prongs 27 or to the outer fork prongs 29′ and the inner fork prongs 29, whereby the picked-up plurality of packaging blanks slide against a centering element 30 due to gravity, whereby the lateral outer edges of the plurality of picked-up packaging blanks are aligned flush with one another.

FIG. 15 shows a schematic view of a further embodiment of a gripper head 10 according to the invention. The embodiment according to FIG. 15 further possesses a separating unit 18 according to the previous description of FIGS. 3A to 3C. The gripper head 10 also comprises a rack 12 as well as a lower gripping unit 19 and an upper gripping unit 17, of which only the lower gripping unit 19 is shown in FIG. 15.

A suction instrument 49 is also a component of the gripper head 10. Such a suction instrument 49 as it shown and described in FIG. 15 is not limited to the embodiment according to FIG. 15, but may be provided in the general context and in all previously described embodiments of a gripper head 10.

A gripper head 10 may also comprise a plurality of such suction instruments.

Instead of or in addition to such a suction instrument 49, a gripper head 10 may also possess other gripping instruments such as at least one needle gripper, at least one adhesion gripper or at least one gripping instrument operating via electrostatic adhesion, or a gripping instrument supported by electrostatic adhesion that can receive a packaging blank.

In practice, it may be that at least one individual packaging blank of a stack 50 remains behind if a plurality of packaging blanks have been removed from stack 50 in a plurality of steps by a gripper head 10. The last packaging blank can be gripped by a suction instrument 49 or by the aforementioned gripping instruments and then brought to a destination via the gripper head 10.

Furthermore, it is conceivable that by such a suction instrument 49 or via the gripping instruments described above, packaging materials which may be, for example, cover boards, straps, intermediate layers or even pallets, are gripped by the suction instrument 49 or by the gripping instruments described above and brought to a predefined destination.

As indicated in FIG. 15 by a depicted arrow, embodiments have proven themselves in which the suction instrument 49 can be brought into different positions relative to the rack 12 by an actuator. This allows even packaging blanks, materials or further objects that are difficult to access to be pneumatically gripped.

Although the suction instrument 49 is configured as a component of the gripper head 10 in the present case, in various embodiments of a packaging system 60 according to the invention it may however be, in addition or alternatively to this, that such a suction instrument 49 is configured as a component of an additional device, with which device a last packaging blank of a stack 50 is pneumatically received, packaging materials are pneumatically gripped, or even a pallet or cover boards are pneumatically received and brought to a desired destination.

FIG. 16 shows a schematic view of a further embodiment of a packaging system 60 according to the invention. The packaging system 60 comprises a manipulator 1 which is an articulated arm robot 1′. The manipulator 1 carries a gripper head 10 which may be configured in particular according to an exemplary embodiment of the previous description.

In the present case, two stacks 50 of packaging blanks are provided via the supply device 80. In further embodiments, there might be only just one stack 50. Also, more than two stacks 50 may be provided which are made available via the supply device 80. The two stacks 50 in the present case are located on a pallet 71.

The manipulator 1 can tightly grip a plurality of packaging blanks from the stack 50 via the gripper head 10 and place them on a tray 62 (not shown in FIG. 16).

The supply device 80 comprises a turntable 72 on which the stacks 50 of packaging blanks are arranged. The turntable 72 can be rotated about a vertically oriented axis, whereby one of the two stacks 50 comes into the access region of the manipulator 1.

It is also possible for a stack 50 to comprise a plurality of packaging blanks which are arranged on the stack 50 in different rotational orientations. If, for example, packaging blanks of the stack 50 possess a longitudinal side and transverse side with different lengths and the manipulator 1 is configured to receive packaging blanks with such a rotational orientation via the gripper head 10, in which rotational orientation the longitudinal side points in the direction of the manipulator 1 or in the direction of the gripper head 10, the given packaging blanks of the stack 50 to be received can be brought into the appropriate rotational orientation intended for reception by a corresponding rotation of the turntable 72, in which the longitudinal side points in the direction of the manipulator 1 or in the direction of the gripper head 10.

In order to align the packaging blanks of the stacks 50 flush with one another, the supply device 80 comprises a stop wall 5. The stop wall 5 can be moved by an actuator in a horizontal direction, thus allowing the packaging blanks of the given stack to be aligned flush with one another.

Furthermore, the supply device 80 comprises a hold-down device 63 which can be placed on one or more stacks 50 in order to fix the given packaging blanks of the given stack 50 on the turntable 72. When the manipulator 1 aligns packaging blanks of a stack 50 flush with one another via the gripper head 10, the hold-down device 63 can fix packaging blanks of a further stack 50 in order to prevent packaging blanks of the further stack 50 from slipping.

The central control S is connected to a sensor system 41 and can detect a given actual height of a given stack 50 via the sensor system 41. Taking into account the given detected actual height, the manipulator 50 is actuated via the central control S in order to clamp in reception packaging blanks from the given stack 50.

The sensor system 41 may, for example, be an optical sensor such as a camera or the like. Alternatively or in addition thereto, the central controller S may detect a given position of the given plurality of packaging blanks to be received via the sensor system 41 and control the manipulator 1 taking into account the detected position of the given plurality of packaging blanks to be received.

Advantageously, this can ensure that the given plurality of packaging blanks are located at an expected target position after clamping reception via the gripper head 10 and are therefore held securely on the gripper head 10.

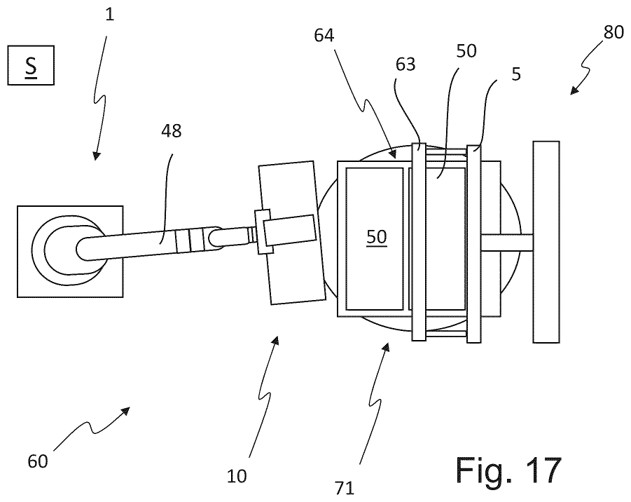

FIG. 17 shows the embodiment of a packaging device 60 according to FIG. 16 in plan view. The manipulator 1 with the gripper head 10, the hold-down device 63 and the stop wall 5 can be seen herein again. The turntable 71 forms a support surface 64 on which the stacks 5 stand upright.

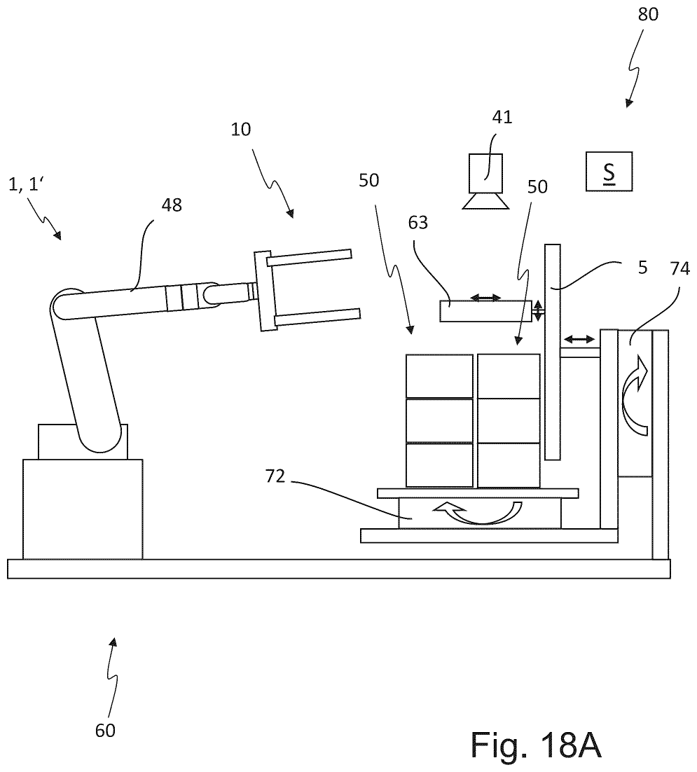

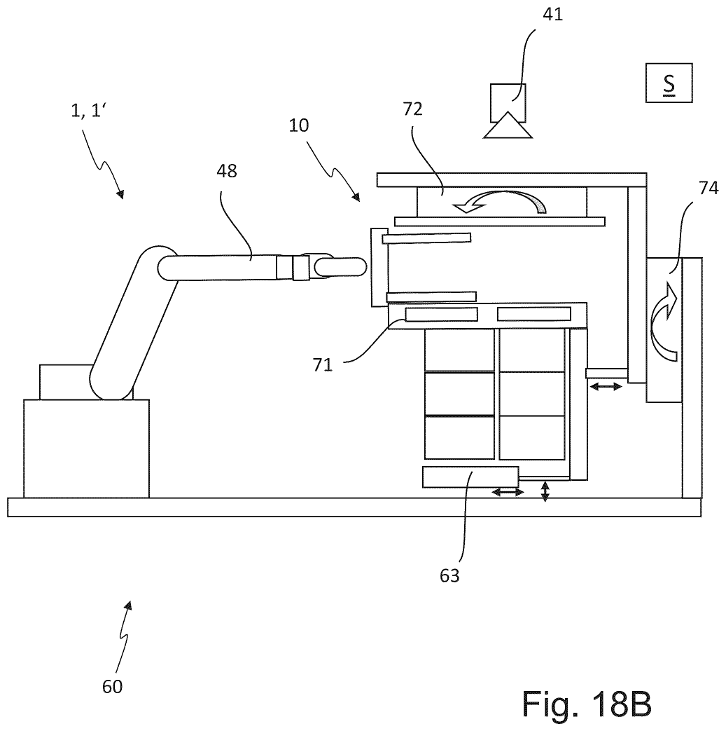

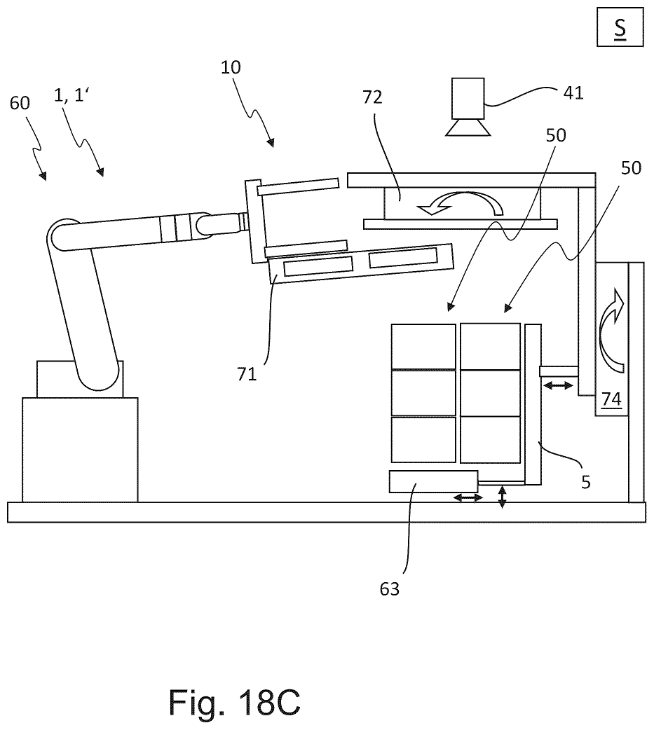

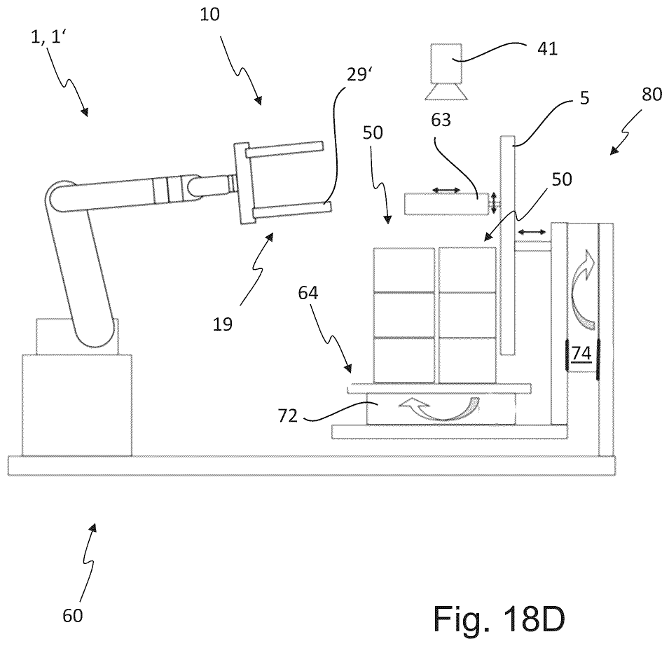

FIGS. 18A to 18D show a schematic view of a further embodiment of a packaging device 60 according to the invention. In addition, FIGS. 18A to 18D show individual steps that may be provided in various embodiments of the method 100 according to the invention.

The embodiment of a packaging device 60 according to FIGS. 18A to 18D differs from the embodiment of a packaging device 60 according to FIG. 17 in particular in that the stop wall 5 as well as the hold-down device 63 and the turntable 72 are rotatable about a common horizontal axis. For this purpose, the stop wall 5, the hold-down device 63 and the turntable 72 are connected to a pivoting device 74.

Such a rotary movement is illustrated by a combination of FIGS. 18A to 18C. In FIG. 18A, a plurality of stacks 50 of packaging blanks are already positioned on the turntable 72 of the supply device 80. The hold-down device 63 is placed on each of the two stacks 50 positioned next to one another and fixes the stacks 50 onto the turntable 72 in a clamping manner. From this point on, the hold-down device 63, the turntable 72 and the stop wall 5 are rotated 180° about a horizontal axis by the pivoting device 74 so that the stacks 5 of packaging blanks stand upright on the hold-down device 63 as shown in FIG. 18B. The turntable 72 has already been raised in FIG. 18B and is spaced apart from the pallet 71. Alternatively thereto, the hold-down device 63 may be lowered together with the stacks 50 relative to the turntable 72 and thereby reach the position according to FIG. 18B.

The gripper head 10 is configured to pick up a pallet 71, as this is also shown in FIG. 18B. For this purpose, the gripper head 10 possesses a device which can plunge into free spaces of the pallet 71 in order to pick up the pallet 71. In various embodiments, it may also be the case that the gripper head 10 plunges with one or more of its forks into one or more free spaces of the pallet 71 and picks up the pallet 71. The pallet 71 may in particular be a Euro pallet. Such a receptacle for a pallet 71 is not limited to the exemplary embodiment according to FIGS. 18A to 18D, but may be provided in a general context and also in particular in the previously already described exemplary embodiments of a packaging system 60 and a gripper head 1.

In FIG. 18B, the manipulator 1 removes the pallet 71 from the stacks 50 of packaging blanks via the gripper head 10. In FIG. 18C, the pallet 71 has already left the stack 50 of packaging blanks.

Following this, the turntable 72 can be placed on the stack 50 of packaging blanks, whereupon the turntable 72, the hold-down device 63 and the stop wall 5 are again rotated by 180° about the horizontal axis via the pivoting device 74 or rotated back by 180°.

The stacks 50 of packaging blanks then stand upright on the turntable 72 as shown corresponding to FIG. 18D without a pallet 71 being located between the turntable 72 and the stacks 50 of packaging blanks.

It has proven useful if the turntable 72 possesses a support surface 62 for the stacks 50 of packaging blanks, which forms a plurality of slots 7 as has already been described for the tray 64 for the exemplary embodiment according to FIG. 8. As a result, the fork prongs 29 and 29′ of the lower gripping unit 19 can plunge into the slots 7 and thus easily remove all the packaging blanks of a stack 50 from the turntable 72.

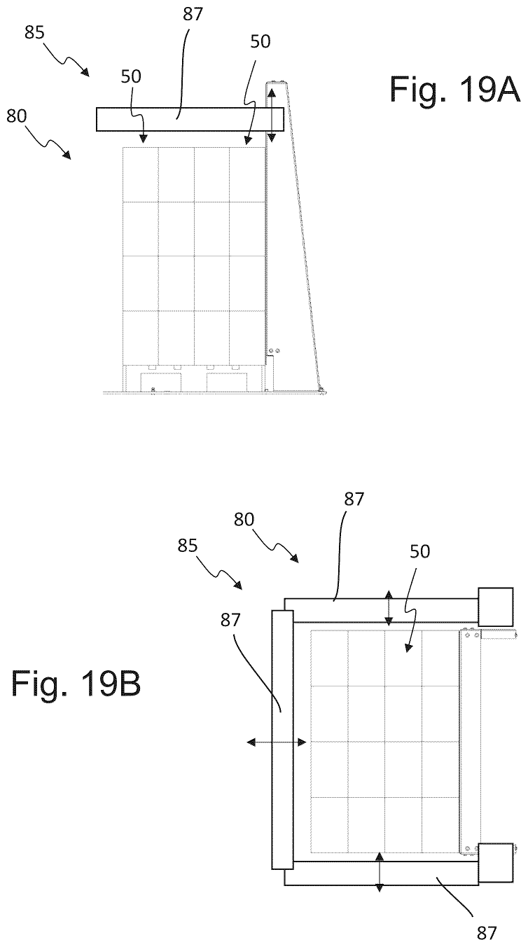

FIGS. 19A and 19B show an exemplary embodiment of a supply device 80 as it may be provided in various exemplary embodiments of a packaging system 60 according to the invention. The supply device 80 comprises a centering device 85 with a plurality of centering bars 87.

As shown in FIG. 19B by an arrow, the centering bars 87 can perform a feed movement. This centers packaging blanks from such stacks 50 which are located in a common plane or are arranged at the same height. Subsequently, the centering bars 87 are moved in a downward direction and are then located in the vertical direction at the height of another level of a plurality of further stacks 50 of packaging blanks.

By a centering movement of the centering bars 87, the packaging blanks of these stacks 50 which are located in the further level are also aligned flush with one another. The centering device 85 thus successively aligns the packaging blanks of stacks 50 which are located in a given common plane flush with one another. As a result, a gripper head 10 can securely pick up and tightly grip a plurality of packaging blanks from a given stack 50 because the given packaging blanks are located at a given expected target position.

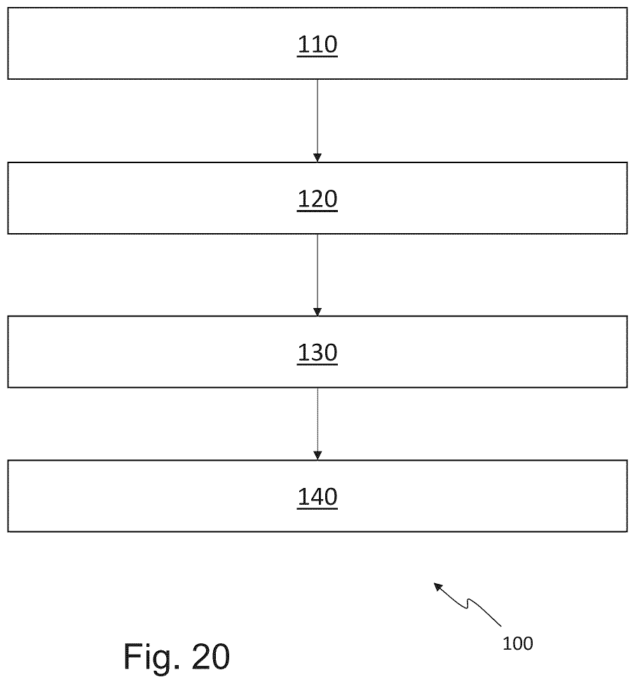

FIG. 20 shows individual steps in a flow diagram as they may be provided in various embodiments of a method 100 according to the invention. In step 110, a gripper head 10 plunges into a stack 50 of packaging blanks via a projection 34 configured as part of a separating unit 18 of the gripper head 10 (see FIGS. 3A to 3C) and then lifts a plurality of packaging blanks arranged on the projection 34 over the separating unit 18.

A rectilinear lifting axis HA along which the projection 34 is moved for this purpose is inclined relative to a contact surface 24 for packaging blanks at an angle which is between 5° and 30°. In particular, the angle may be 18° or substantially 18°.

In step 120, a lower gripping unit 19 of the gripper head 10 is inserted into the stack 50 of packaging blanks in the region of the raised outer edges so that the given packaging blanks still to be tightly gripped are completely carried by the lower gripping unit 19.

In step 130, the packaging blanks completely carried by the lower gripping unit 19 are tightly gripped by the lower gripping unit 19 and an upper gripping unit 17 of the gripper head 10 and subsequently transported in step 140 via the gripper head 10 in the direction of a predefined destination. A manipulator 1 may be provided for the movement of the gripper head 140, which may in particular be an articulated arm robot 1′. At the destination, there may be a packaging device to which the plurality of packaging blanks are transferred from the gripper head 10.

The invention has been described with reference to a preferred embodiment. However, it is conceivable for a person skilled in the art that modifications or changes can be made to the invention without departing from the scope of protection of the following claims.

### LIST OF REFERENCE SIGNS

1 manipulator
1′ articulated arm robot
2 packaging system
3 adapter
4 linear guide
5 stop wall
6 opening
7 slot
8 sheet metal part
9 piston-cylinder unit
10 gripper head
12 rack
13 actuator
14 carrying frame
15 tongs
16 linear actuator
17 upper gripping unit
18 separating unit
19 lower gripping unit
20 control and/or regulating device
23 coupling
24 contact surface
25 pneumatic cylinder
26 pneumatic cylinder
26′ clamping device
27 first fork prong
28 fork prong
29 inner fork prong
29′ outer fork prong
30 carriage
32 stop
34 projection
36 interface with the gripping unit
37 rack
38 surface
39 centering element
41 sensory system
42 piston
43 mat strip
46 bearing
48 working arm
49 suction instrument
50 stack
51 further stack
52 further stack
53 further stack
54 further stack
55 further stack
56 further stack
57 further stack
60 packaging system
62 tray
63 hold-down device
64 support surface
67 slot
69 transport belt
70 centering apparatus
71 pallet
72 turntable, first turntable
74 turntable, second turntable
80 supply device
85 centering apparatus
87 centering bar
100 method
110 method step, first method step
120 method step, second method step
130 method step, third method step
140 method step, fourth method step
HA lifting axis
L gap
S central control

1. A system for manipulating packaging blanks, comprising:
a gripper head having:
an upper gripping unit (17) and a lower gripping unit (19) which are configured to grip one or more packaging blanks from a stack (50) of packaging blanks, and
a separating unit (18) which is configured to lift outer edges of packaging blanks intended to be gripped relative to packaging blanks remaining on the stack (50) so that the lower gripping unit (19) can be inserted into the stack (50) of packaging blanks in the region of the raised outer edges,
wherein the separating unit (18) comprises a linear actuator (16) which is arranged in such a way that its rectilinear lifting axis (HA) is inclined relative to a contact surface (24).

2. (canceled)

3. The system of claim 1, wherein the rectilinear lifting axis (HA) is inclined relative to the contact surface (24) at an angle which is between 5° and 30°.

4. (canceled)

5. The system of claim 1, wherein the upper gripping unit (17) comprises at least two fork prongs (27) oriented parallel to one another, or wherein the lower gripping unit (19) comprises two outer fork prongs (29′) and two inner fork prongs (29), wherein the two outer fork prongs (29′) or the two inner fork prongs (29) are adjustable such that the two outer fork prongs (29′) can be brought into a common plane with the two inner fork prongs (29).

6. (canceled)

7. The system of claim 1, wherein the upper gripping unit (17) and/or the lower gripping unit (19) are arranged on a straight guide, wherein the upper gripping unit (17) or the lower gripping unit (19) are movable along the straight guide for gripping the plurality of packaging blanks.

8. (canceled)

9. The system of claims 1, wherein the upper gripping unit (17) is pivotable.

10. The system of claim 1, wherein the separating unit (18) is arranged on the lower gripping unit (19).

11. The system of claims 1, wherein the separating unit (18) is arranged on the upper gripping unit (17).

12. The system of claim 1, wherein the separating unit (18) comprises a carriage (30) on which the at least one linear actuator (16) is arranged, wherein the carriage (30) is movable in a straight line along a guide of the gripper head (10) together with the at least one linear actuator (16).

13. (canceled)

14. The system of claim 1, wherein the separating unit (18) comprises a stop (32) which is movable via the at least one linear actuator (16) and is configured for flush alignment of outer edges of the packaging blanks, wherein the stop (32):
is connected to the at least one linear actuator (16) such that the stop (32) is inclined in the direction opposite the outer edges when the stop (32) aligns flush the outer edges of the packaging blanks intended for the given gripping and/or wherein
the stop (32) is movable via the at least one linear actuator (16) in such a way that the stop (32) executes an inclination movement oriented in the direction opposite the outer edges during the lifting of the outer edges.

15. (canceled)

16. The system of claim 1, wherein the separating unit (18) comprises a projection (34) which is movable along the rectilinear lifting axis (HA) by the at least one linear actuator (16).

17. The system of claim 1, further comprising at least one suction instrument (49) configured such that the gripper head (1) can pneumatically receive a packaging blank.

18. The system of claim 17, wherein a position of the at least one suction instrument (49) is adjustable by actuator.

19. The system of claim 1 further comprising: a manipulator (1), having a an articulated arm robot (1′), to which at least one gripper head (10) is connected.

20. (canceled)

21. The system of claim 19 further comprising a supply device (80) for receiving at least one stack (50) of flat packaging blanks, and a packaging device for packaging articles using packaging blanks, wherein the supply device (80) and the packaging device are located within a working range of the at least one manipulator (1), and wherein the at least one manipulator (1) is configured to transfer given packaging blanks tightly gripped by its gripper head (10) to the packaging device.

22. A method (100) for manipulating packaging blanks via a gripper head (10) which possesses a lower gripping unit (19), an upper gripping unit (17), and a separating unit (18), wherein a stack (50) of packaging blanks is provided, the method comprising:
lifting, with the gripper head (10), outer edges of given packaging blanks to be clamped relative to further packaging blanks remaining on the stack (50) wherein the lifting step comprises actuating at least one linear actuator (16) of the separating unit (18) which takes place along a rectilinear lifting axis (HA), wherein rectilinear lifting axis (HA) is inclined relative to a contact surface (24) for packaging blanks,
introducing the lower gripping unit (19) into the stack (50) of packaging blanks in the region of the raised outer edges,
gripping the packaging blanks with the lower gripping unit (19) and the upper gripping unit (17), and
moving the gripper head (10), together with the gripped packaging blanks away from the stack (50).

23. (canceled)

24. (canceled)

25. The method (100) of claim 22, wherein a stop (32) is connected to the at least one linear actuator (16), and further comprising moving the gripper head (10) in the direction of the packaging blanks on the stack (5) before lifting the outer edges so that the stop (32) comes into surface contact with the outer edges of the packaging blanks and aligns the outer edges of the packaging blanks flush or substantially flush with one another.

26. The method (100) of claim 25, wherein:
the stop (32) is inclined a return stroke movement of the at least one linear actuator (16) in the direction opposite the given packaging blanks, while the outer edges of the given packaging blanks are raised above the separating unit (18), or in which method:
the stop (32) is connected to the linear actuator (16) such that the stop (32) is inclined in the opposite direction of the outer edges during the flush or substantially flush alignment of the given outer edges.

27. The method (100) of claim 25, further comprising pressing, with the stop (32), the packaging blanks against a stop wall (5) and, in doing so, aligning the outer edges of the packaging blanks flush or substantially flush with one another.

28. (canceled)

29. The method (100) of claim 22, wherein the lower gripping unit (19) comprises at least two inner fork prongs (29) and at least two outer fork prongs (29′), wherein only the at least two inner fork prongs (29) are introduced into the stack (50) in the region of the raised outer edges and pick up the given packaging blanks to be tightly gripped so that the given packaging blanks to be tightly gripped are completely carried by the at least two inner fork prongs (29), wherein subsequently, the at least two outer fork prongs (29′) are brought into contact with an already picked up packaging blanks, and the packaging blanks to be gripped are thereby carried both by the at least two inner fork prongs (29) and by the at least two outer fork prongs (29′).

30. The method (100) of claim 22, wherein the lower gripping unit (19) is introduced into the stack (50) of packaging blanks in the region of the raised outer edges and completely or partially picks up the packaging blanks to be gripped so that the packaging blanks are completely or partially carried by the lower gripping unit (19), and wherein at least one centering element (39), configured as a component of the gripper head (10), is moved and aligns the plurality of completely or partially picked-up packaging blanks flush with one another.

31. The method (100) of claim 22, wherein the gripper head (10) comprises at least one suction instrument (49) via which the gripper head (10) pneumatically receives a last packaging blank of the stack (50) of packaging blanks formed up to that point, whereupon the gripper head (10) transports the pneumatically picked-up packaging blank away from the stack (50).

32.-40. (canceled)
